(19) United States
(12) Patent Application Publication
(10) Pub. No.: US 2015/0248221 A1
(43) Pub. Date: Sep. 3, 2015

(54) IMAGE PROCESSING DEVICE, IMAGE PROCESSING METHOD, IMAGE PROCESSING SYSTEM, AND NON-TRANSITORY COMPUTER READABLE MEDIUM

(71) Applicant: FUJI XEROX CO., LTD., Tokyo (JP)

(72) Inventors: Makoto SASAKI, Kanagawa (JP); Shota NARUMI, Kanagawa (JP)

(73) Assignee: FUJI XEROX CO., LTD., Tokyo (JP)

(21) Appl. No.: 14/467,176

(22) Filed: Aug. 25, 2014

(30) Foreign Application Priority Data
Feb. 28, 2014 (JP) 2014-039868

(51) Int. Cl. G06F 3/0484; G06F 3/0488; G06F 3/041

(52) U.S. Cl. CPC G06F 3/04845; G06F 3/041; G06F 3/0488

(57) ABSTRACT

An image processing device includes an image information acquiring unit that acquires image information of an image that is subjected to image processing, a path information acquiring unit that acquires position information of a path of an operation inputted by a user on the image, a calculation unit that calculates a magnitude of the path from the position information of the path, and an image processing unit that changes a degree to which to perform the image processing in accordance with the magnitude of the path, and performs the image processing with respect to the image.

### CROSS-REFERENCE TO RELATED APPLICATIONS

This application is based on and claims priority under 35 USC 119 from Japanese Patent Application No. 2014-039868 filed Feb. 28, 2014.

### BACKGROUND

The present invention relates to an image processing device, an image processing method, an image processing system, and a non-transitory computer readable medium.

### SUMMARY

According to an aspect of the invention, there is provided an image processing device including an image information acquiring unit that acquires image information of an image that is subjected to image processing, a path information acquiring unit that acquires position information of a path of an operation inputted by a user on the image, a calculation unit that calculates a magnitude of the path from the position information of the path, and an image processing unit that changes a degree to which to perform the image processing in accordance with the magnitude of the path, and performs the image processing with respect to the image.

### BRIEF DESCRIPTION OF THE DRAWINGS

Exemplary embodiments of the present invention will be described in detail based on the following figures, wherein:

FIG. 1 illustrates an example of the functional configuration of an image processing system according to the exemplary embodiments;

FIG. 2 is a block diagram illustrating an example of the functional configuration of an image processing device according to a first exemplary embodiment of the invention;

FIG. 3 illustrates an example of an image displayed on a display screen of a display;

FIG. 4 explains a path inputted on a display screen;

FIGS. 5A to 5C illustrate how an image changes in a case where visibility is adjusted as image processing;

FIGS. 6A and 6B illustrate an object displayed on a display screen, and the brightness histogram of this object, respectively;

FIGS. 7A and 7B illustrate an image obtained when the glossiness of an object is increased relative to the image illustrated in FIG. 6A, and a brightness histogram at this time, respectively;

FIGS. 7C and 7D illustrate an image obtained when the matteness of an object is increased relative to the image illustrated in FIG. 6A, and a brightness histogram at this time, respectively;

FIG. 8 illustrates a case where perception control is adjusted as image processing;

FIG. 9 is a flowchart illustrating operation of the image processing device according to the first exemplary embodiment;

FIG. 10 is a block diagram illustrating an example of the functional configuration of an image processing device according to a second exemplary embodiment of the invention;

FIGS. 11A and 11B each illustrate the relationship between the input direction of a path and an image processing parameter;

FIGS. 12A and 12B each illustrate an example of an adopted image processing parameter;

FIGS. 13A and 13B illustrate functions f_{H}(H) and f_{S}(S), respectively;

FIG. 14 illustrates how the function f_{H}(H) is updated when a path in the vertical direction is inputted multiple times;

FIG. 15 illustrates an example of an image displayed on a display screen when adjusting spatial frequency;

FIG. 16 illustrates images obtained after image processing is performed as a result of the operation illustrated in FIG. 15;

FIG. 17 is a flowchart illustrating operation of the image processing device according to the second exemplary embodiment;

FIG. 18 is a block diagram illustrating an example of the functional configuration of an image processing device according to a third exemplary embodiment of the invention;

FIG. 19 illustrates an example of a path inputted by a user according to the third exemplary embodiment;

FIG. 20 illustrates an example of a method of calculating the size of a path;

FIGS. 21A and 21B illustrate a method of determining the shape of a path;

FIGS. 22A to 22E illustrate how the results of image processing differ depending on the size of a path;

FIG. 23 is a flowchart illustrating operation of the image processing device according to the third exemplary embodiment;

FIG. 24 is a block diagram illustrating an example of the functional configuration of an image processing device according to a fourth exemplary embodiment of the invention;

FIGS. 25A and 25B each illustrate an example of an image displayed on a display screen when switching items of image processing;

FIG. 26 is a flowchart illustrating operation of the image processing device according to the fourth exemplary embodiment;

FIG. 27 is a block diagram illustrating an example of the functional configuration of an image processing device according to a fifth exemplary embodiment of the invention;

FIG. 28 illustrates an example of a method of cropping a specified region in an interactive manner;

FIG. 29-1 explains the max-flow/min-cut principle;

FIGS. 29-2A to 29-2E illustrate a specific example of how an image is divided into two regions in a case where two seeds are given;

FIGS. 30A to 30C illustrate how a specified region is cropped from an original image;

FIG. 31 illustrates an example of a mask for cropping a specified region;

FIGS. 32-1A to 32-1C illustrate a case where a user crops a specified region, and further, image processing is performed thereafter;

FIGS. 32-2A and 32-2B illustrate a case where a Crop button illustrated in FIGS. 32-1A to 32-1C is not provided;

FIG. 33 is a flowchart illustrating operation of the image processing device according to the fifth exemplary embodiment; and

FIG. 34 illustrates a hardware configuration of an image processing device.

### DETAILED DESCRIPTION

Hereinafter, exemplary embodiments of the invention will be described in detail with reference to the attached figures.

### Background of the Invention

In related art, image processing is commonly performed with a personal computer (PC) by making full use of a mouse. There are a wide variety of application software for performing image processing, ranging from free software for performing image processing in a simple manner to retouching software represented by Photoshop from Adobe Systems Inc. used by skilled users.

Recent years have seen a rapid increase in use of information and communication technology (ICT) devices represented by tablet terminals, which are directly touched by humans to enable highly intuitive operation, such as a touch or tap. Further, ICT devices have increasingly higher color image display capabilities and color reproducibility, and image processing is also becoming more sophisticated.

Against the above-mentioned backdrop, the following technique exists as an example of related art to perform intuitive, user-interactive operation. According to this technique, in order to perform brightness adjustment in a simple manner in small ICT devices such as cellular phones, the degree of adjustment is controlled in accordance with the number of times the image being displayed is traced or the speed with which the image is traced. Further, a technique also exists in which a specific region of a color image is specified, and an indicator is displayed on a rectangle circumscribing the specific region. Then, the indicator is moved in the horizontal direction to correct hue, and the indicator is moved in the vertical direction to correct saturation.

In this regard, in the case of image processing performed by ICT devices equipped with a touch panel, in particular, it is becoming a challenge to increase intuitiveness when performing image processing.

However, increasing intuitiveness means compromising the degree of freedom or operability of image processing in many cases. For example, in such cases, adjustment is made only for brightness, or even if two degrees of freedom of adjustment are possible such as for hue and saturation, it has been traditionally difficult to switch to another image quality adjustment (such as brightness adjustment or frequency band adjustment) or the like.

In view of the above-mentioned circumstances, according to the exemplary embodiments, the above-mentioned problem is minimized by use of an image processing system 1 described below.

<Description of Overall Image Processing System>

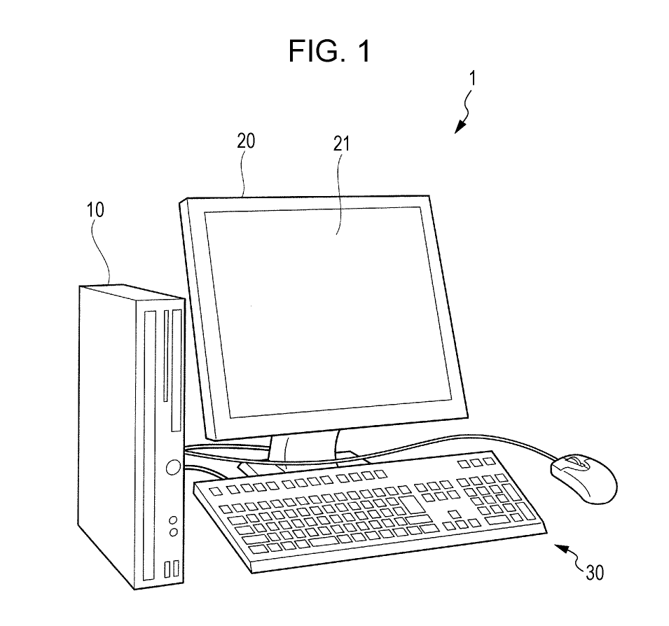

FIG. 1 illustrates an example of the configuration of the image processing system 1 according to the exemplary embodiments.

As illustrated in FIG. 1, the image processing system 1 according to the exemplary embodiments includes an image processing device 10 that performs image processing with respect to image information displayed on a display 20, the display 20 to which image information created by the image processing device 10 is inputted and which displays an image on the basis of this image information, and an input device 30 used by a user to input various information to the image processing device 10.

The image processing device 10 is, for example, a so-called general-purpose computer (PC). In the image processing device 10, for example, image information is created by running various application software under control of the operating system (OS).

The display 20 displays an image on a display screen 21. The display 20 is configured by a display including the function of displaying an image by additive mixture of colors, for example, a liquid crystal display for a PC, a liquid crystal television, or a projector. Therefore, the display format of the display 20 is not limited to the liquid crystal format. In the example illustrated in FIG. 1, the display screen 21 is provided inside the display 20. However, in a case where, for example, a projector is used as the display 20, the display screen 21 is a screen or the like provided outside the display 20.

The input device 30 is configured by a keyboard, a mouse, or the like. The input device 30 is used to input an instruction to start or end application software used for performing image processing or, as will be described later in detail, is used by the user when performing image processing to input an instruction for performing image processing with respect to the image processing device 10.

The image processing device 10 and the display 20 are connected via a Digital Visual Interface (DVI). Instead of a DVI, the image processing device 10 and the display 20 may be connected via a High-Definition Multimedia Interface (HDMI), a DisplayPort, or the like.

The image processing device 10 and the input device 30 are connected via, for example, a Universal Serial Bus (USB). Instead of a USB, the image processing device 10 and the input device 30 may be connected via an IEEE1394, RS-232C, or the like.

In the image processing system 1 as described above, an original image, which is an image that has not yet undergone image processing (hereinafter, also referred to as “pre-processing image”), is first displayed on the display 20. Then, when the user inputs an instruction for performing image processing to the image processing device 10 by using the input device 30, image processing is performed with respect to the image information of the original image by the image processing device 10. The results of this image processing are reflected on the image to be displayed on the display 20, and an image that has undergone image processing (hereinafter, also referred to as “post-processing image”) is rendered again and displayed on the display 20. In this case, the user is able to perform image processing interactively while looking at the display 20, which allows the user to proceed with the image processing more intuitively or more easily.

The image processing system 1 according to the exemplary embodiments is not limited to the form illustrated in FIG. 1. For example, a tablet terminal may be exemplified as the image processing system 1. In this case, the tablet terminal includes a touch panel, and this touch panel is used to display an image as well as input an instruction from the user. That is, the touch panel functions as the display 20 and the input device 30. Likewise, a touch monitor may be used as a device that combines the display 20 and the input device 30. In this example, a touch panel is used as the display screen 21 of the display 20 mentioned above. In this case, image information is created by the image processing device 10, and an image is displayed on the touch monitor on the basis of this image information. Then, the user inputs an instruction for performing image processing by, for example, touching this touch monitor.

### Description of Image Processing Apparatus

### First Exemplary Embodiment

Next, a first exemplary embodiment of the image processing device 10 will be described.

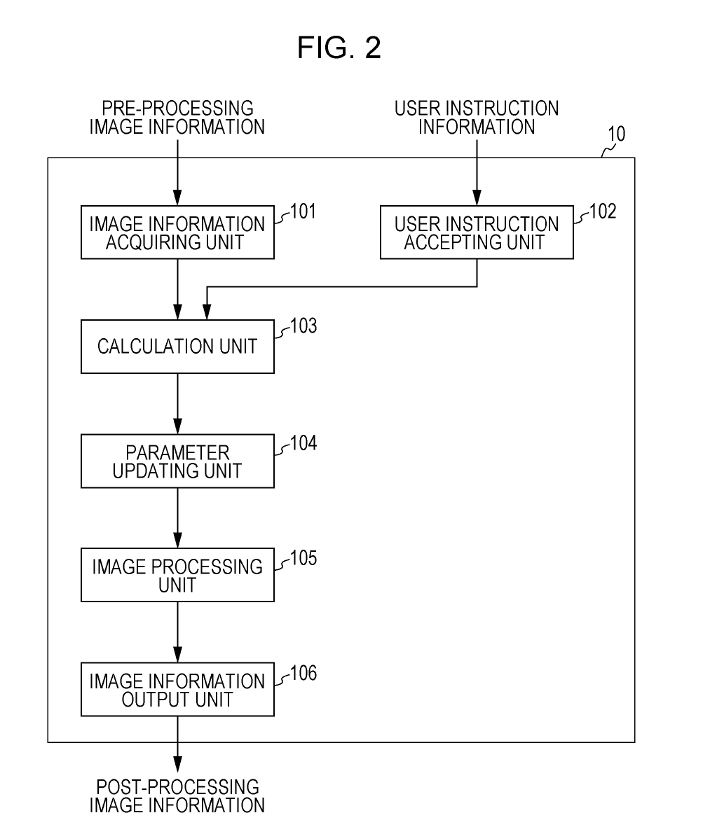

FIG. 2 is a block diagram illustrating an example of the functional configuration of the image processing device 10 according to the first exemplary embodiment of the invention. In FIG. 2, among various functions included in the image processing device 10, those functions which are related to the first exemplary embodiment are selected and depicted.

As illustrated in FIG. 2, the image processing device 10 according to the first exemplary embodiment includes an image information acquiring unit 101, a user instruction accepting unit 102, a calculation unit 103, a parameter updating unit 104, an image processing unit 105, and an image information output unit 106.

The image information acquiring unit 101 acquires image information of an image that is subjected to image processing. That is, the image information acquiring unit 101 acquires image information that has not undergone image processing yet (hereinafter, also referred to as “pre-processing image information”). This image information is, for example, video data in Red-Green-Blue (RGB) format (RGB data) for display on the display 20.

The user instruction accepting unit 102 is an example of a path information acquiring unit. The user instruction accepting unit 102 accepts a user's instruction related to image processing which is inputted with the input device 30.

Specifically, the user instruction accepting unit 102 accepts position information of the path of an operation inputted by the user on an image displayed on the display 20, as user instruction information.

This path may be inputted with the input device 30. Specifically, in a case where the input device 30 is a mouse, the image being displayed on the display 20 is dragged to draw a path by operating the mouse. Likewise, in a case where the input device 30 is a touch panel, a path is drawn by performing a trace swipe on the display screen 21 with a user's finger, a touch pen, or the like.

The calculation unit 103 calculates the magnitude of a path from position information of the path.

In the first exemplary embodiment, the length of a patch in one direction is calculated as the magnitude of the path.

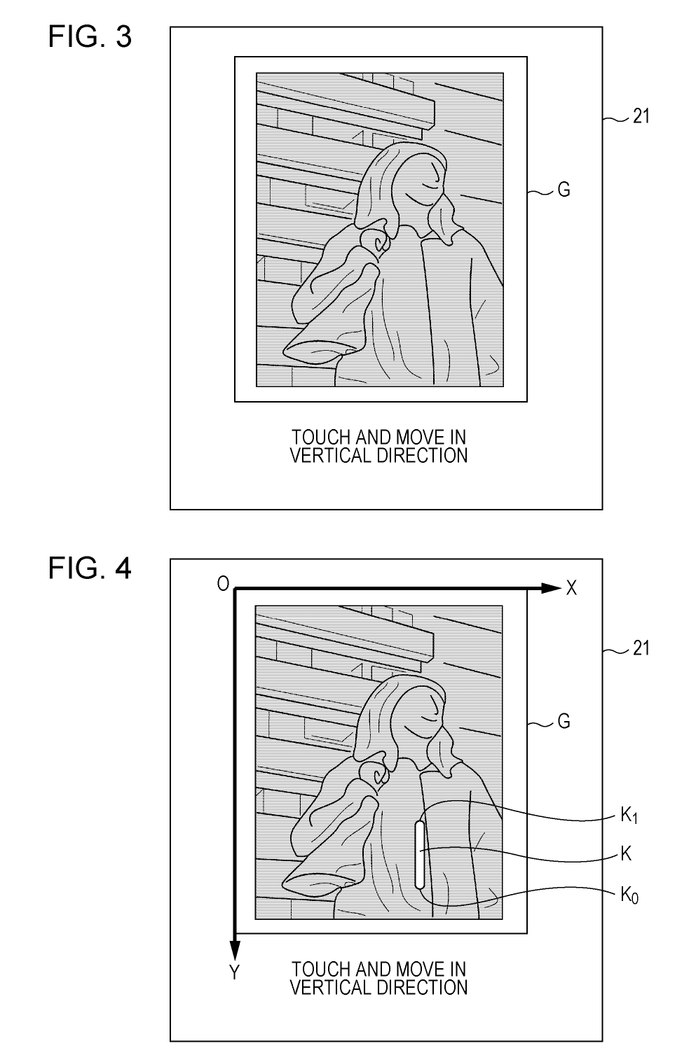

FIG. 3 illustrates an example of an image displayed on the display screen 21 of the display 20.

In this case, the image displayed on the display screen 21 is an image G of a photograph including a person shown as a foreground, and a background shown behind the person. A message “Touch and move in vertical direction” is displayed underneath the image G. In this case, it is assumed that the display screen 21 is a touch panel.

At this time, following this message, the user swipes the image G to input a path in a generally vertical direction (up/down direction in FIG. 3). Then, the user instruction accepting unit 102 acquires position information of the inputted path, and the calculation unit 103 calculates the length of the path from the positions of the starting point and end point of this path on the display screen 21.

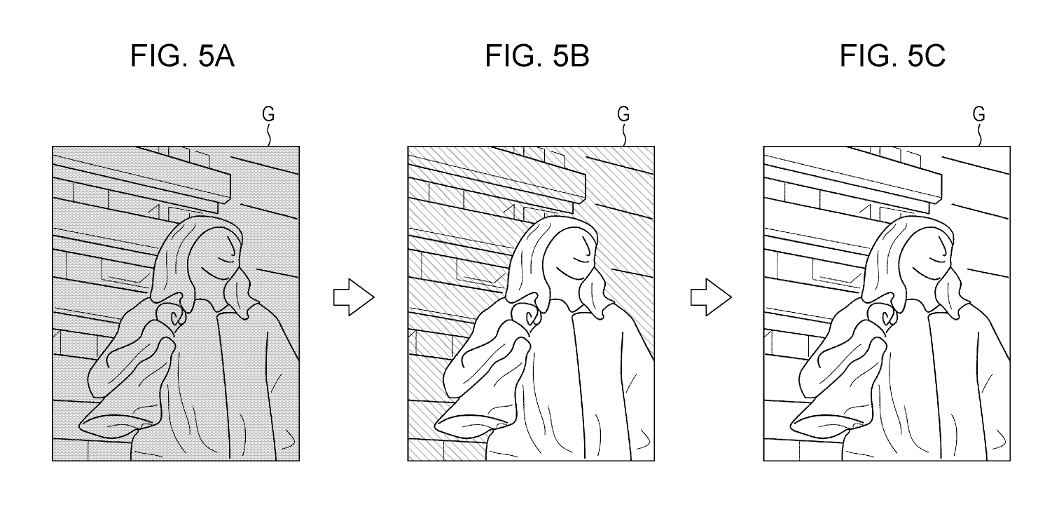

FIG. 4 explains a path inputted on the display screen 21.

FIG. 4 illustrates a case where the user inputs a path K on the image G. The upper left apex of the image G is taken as origin O, the rightward direction from the origin O is taken as X-direction, and the downward direction from the origin O is taken as Y-direction. The calculation unit 103 calculates the respective coordinates of a starting point K₀ and end point K₁ of the path K from position information of the path K. In this example, let the coordinates of the starting point K₀ be (X₀, Y₀), and the coordinates of the end point K₁ be (X₁, Y₁). Then, on the basis of the movement in the X-direction |X₀−X₁| and the movement in the Y-direction |Y₀−Y₁|, the calculation unit 103 determines whether or not the condition represented by Formula 1 below is satisfied. While the path K is depicted as being located on the display screen 21 for the convenience of explanation, the path K may not necessarily be actually displayed on the display screen 21. Further, the initial position on the display screen 21 at which to place a finger or the like may be anywhere (may not necessarily be determined in advance). This reduces the stress the user may otherwise feel if the position at which to place a finger or the like is determined in advance as in the case of a slider, thereby improving convenience.

|X₀−X₁|<|Y₀−Y₁| [Formula 1]

In a case where the condition of Formula 1 is satisfied, the calculation unit 103 determines that the path is inputted in the vertical direction, and treats |Y₀−Y₁| as the length of the path. In a case where the condition of Formula 1 is not satisfied, the calculation unit 103 determines that the path is inputted in the horizontal direction, and treats the length of the path as being zero even if |Y₀−Y₁| takes a value other than zero. The actual length of the path may be treated as the length of the path as it is.

The parameter updating unit 104 reflects the length of the path on an image processing parameter.

For example, letting α be an image processing parameter, and Δα be an increase or decrease of α. In this case, the length of the path and Δα may be associated with each other in the relationship represented by Formula 2 below.

Δα=k(Y₀−Y₁) [Formula 2]

In Formula 2, k is a proportionality constant. As the value of k is set to be smaller, the sensitivity of update of the image processing parameter α may be reduced, and as the value of k is set to be larger, the sensitivity of update of the image processing parameter α may be improved.

Further, the larger the value of |Y₀−Y₁|, the larger the value of Δα. That is, the degree to which to perform image processing is changed in accordance with the magnitude of the path. At this time, inputting the path in the upward direction (swiping the image G from down to up) results in a positive value of Δα, thus causing α to increase. To the contrary, inputting the path in the downward direction (swiping the image G from up to down) results in a negative value of Δα, thus causing α to decrease.

Letting the image processing parameter after the update be α′, the image processing parameter α′ is represented as Formula 3 below.

α′=α+Δα [Formula 3]

Normally, software using a graphical user interface (GUI) has a mechanism for constantly monitoring an event represented by movement of a mouse (or a touched finger). Therefore, such software is able to obtain information of Δα at each instant in time, and cause the quality of an image to change as the mouse or finger moves.

Further, releasing the mouse or finger and then touching on again causes α in Formula 3 to become α′, and re-update is done as represented by Formula 4 below by repeating the same processing as the processing that has been described above.

α″=α′+Δα′ [Formula 4]

In Formula 4, Δα′ denotes the result of calculation of Formula 2 started from when a finger is released and then touched on again, and α′ is re-updated to α″. Further, releasing a mouse or finger and then touched on again causes re-update is be further performed in the same manner.

The image processing unit 105 performs image processing with respect to an image on the basis of the image processing parameter α′. Details of this image processing will be described later.

The image information output unit 106 outputs image information that has undergone image processing as mentioned above (hereinafter, also referred to as “post-processing image information). The post-processing image information is sent to the display 20. Then, an image is displayed on the display 20 on the basis of this image information.

Next, details of image processing executed in the image processing unit 105 will be described.

In this case, for example, image processing for controlling the texture of an image is performed. Further, in this case, a description will be made of image processing for controlling visibility as an example of image processing for controlling the texture of an image. Improving visibility means making an object to be seen appear clearly, and the Retinex principle may be given as a representative example of image processing for achieving this. With methods that simply adjust a tone curve as image processing, only the overall brightness of an image improves. However, according to the Retinex principle, brightness may be adjusted in accordance with pixels and their neighbors.

The Retinex principle considers that the pixel value I(x, y) of an image is made up of a reflectance component and an illumination component. This may be represented by Formula 5 below. In Formula 5, I_{R}(x, y) denotes the reflectance component of a pixel located at (x, y), and L(x, y) denotes the illumination component of the pixel located at (x, y).

I(x,y)=I_{R}(x,y)L(x,y) [Formula 5]

It is considered that according to the characteristics of human visual perception, the reflectance component represented by Formula 5 contributes greatly to the perception of geometries or surfaces. Accordingly, emphasizing the reflectance component I_{R}(x, y) is the basis of visibility control based on the Retinex principle.

Decomposing the pixel value I(x, y) into two components as in Formula 5 is traditionally regarded as an ill-posed problem. Accordingly, it is a precondition for visibility reproduction based on the Retinex principle to estimate the illumination component L(x, y) by some method. The following method is frequently used to this end. That is, for an original image, filtered images are generated by applying a low-pass filter and synthesized, and the filtered result is defined as the illumination component L(x, y).

As for the pixel value I(x, y) used in the case of performing visibility reproduction based on the Retinex principle, there are both a case where all of the RGB data are used, and a case where RGB data is converted into HSV data and visibility reproduction is performed by using only the V data. Alternatively, the L* data of the L*a*b* data, or the Y data of the YCbCr data may be used. Further, brightness may be uniquely defined.

Conversion from the pixel value I(x, y) of an original image into a pixel value I′(x, y) with improved visibility may be represented as, for example, Formula 6 below.

I′(x,y)=αI_{R}(x,y)+(1−α)I(x,y) [Formula 6]

In Formula 6, α denotes a reflectance emphasis parameter for emphasizing the reflectance component, and falls within a range of 0≦α≦1. When α=0, this results in the pixel value I(x, y) being maintained as it is, and when α=1, this results in the pixel value I(x, y) being equal to the reflectance component I_{R}(x, y).

The reflectance emphasis parameter α in Formula 6 may be treated as the image processing parameter α in Formula 3. Visibility may be adjusted by adjusting this reflectance emphasis parameter α.

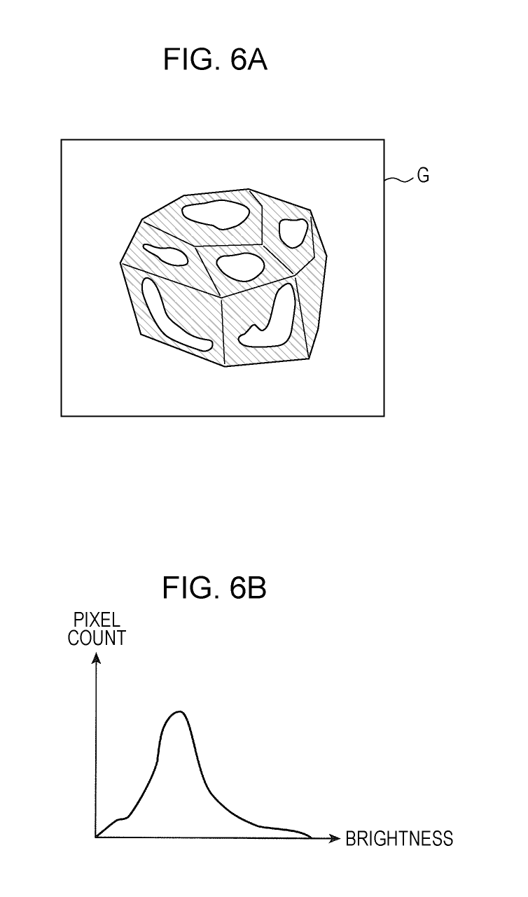

FIGS. 5A to 5C illustrate how an image changes in a case where visibility is adjusted as image processing.

The image G in FIG. 5A is an original image, which is an image prior to undergoing visibility adjustment.

FIG. 5B illustrates a state when the user inputs a path in the vertical direction by performing an upward swipe on the image G once. At this time, the reflectance emphasis parameter α increases by a predetermined amount, and visibility improves.

Further, FIG. 5C illustrates a state when the user inputs a path in the vertical direction by performing an upward swipe on the image G once again. At this time, the reflectance emphasis parameter α further increases by a predetermined amount, and visibility further improves.

In this way, the reflectance emphasis parameter α is sequentially updated in accordance with Formula 3 by an amount corresponding to the number of swipes performed. When the user performs a downward swipe on the image G, the reflectance emphasis parameter α decreases by a predetermined amount, and visibility is reduced.

While α is in the range of 0≦α≦1 in the above-mentioned example, this is not to be construed restrictively. A narrower range may be set in advance as a range within which image processing may be performed appropriately. That is, a limit may be provided within the range of 0 to 1.

ICT devices, in particular, are convenient to carry around and are used in different environments. Different environments mean different ambient lighting conditions, such as outdoor environments of slightly strong sunlight, indoor dimly lit areas, and indoor well lit areas. The image processing method according to the first exemplary embodiment makes it possible to adjust visibility easily in the case of displaying images under these diverse environments.

Next, a description will be made of image processing for adjusting perception control as image processing for controlling texture.

Properties typically perceived by humans with respect to a surface include glossiness and matteness.

These glossiness and matteness may be quantified by calculating the skewness of a brightness histogram. That is, this skewness of a brightness histogram may be treated as the image processing parameter α.

Hereinafter, the skewness of a brightness histogram will be described.

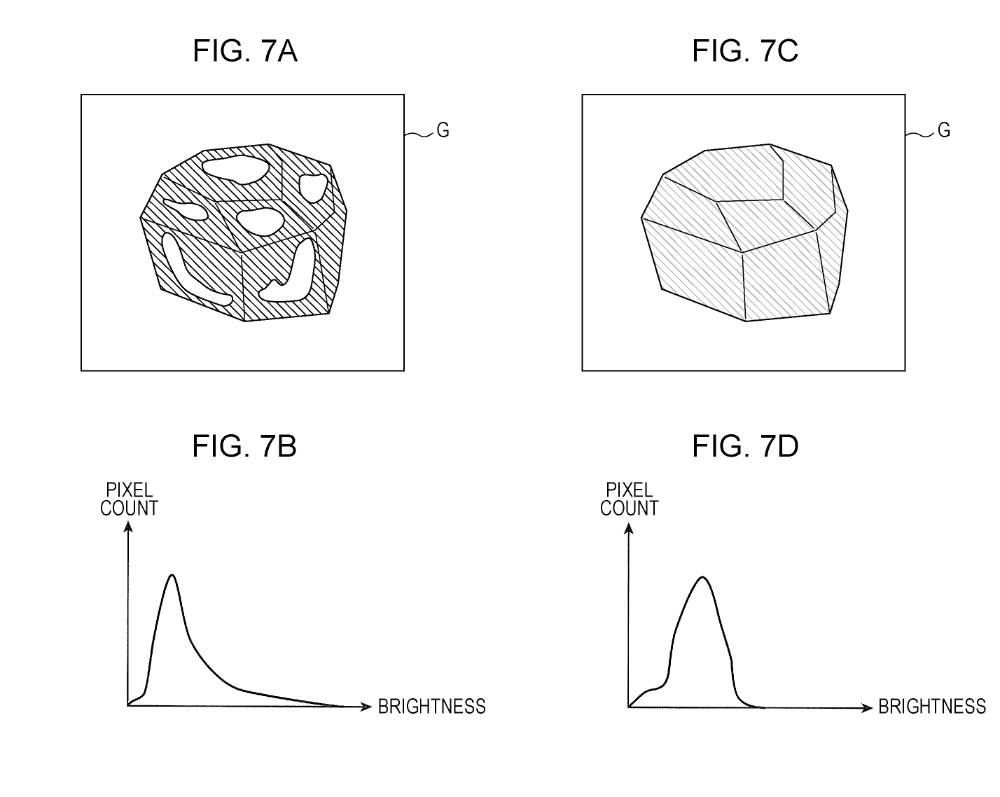

FIG. 6A illustrates an object displayed on the display screen 21, and FIG. 6B illustrates the brightness histogram of this object. In FIG. 6B, the horizontal axis represents brightness, and the vertical axis represents pixel count. The brightness histogram in this case has a typical shape.

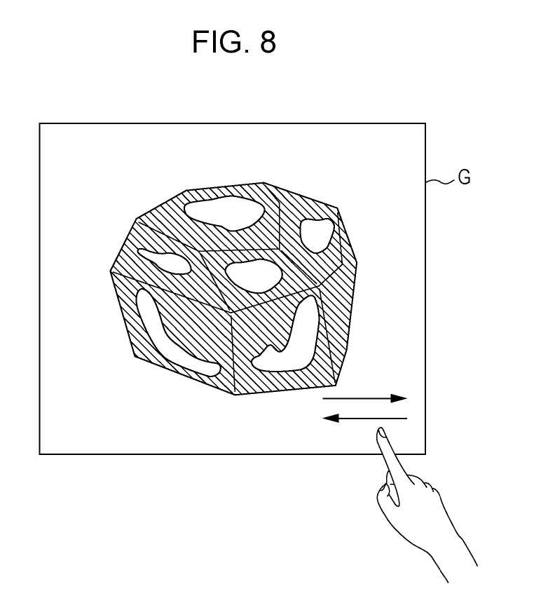

FIG. 7A illustrates an image obtained when the glossiness of the object is increased relative to the image illustrated in FIG. 6A. FIG. 7B illustrates the brightness histogram at this time.

Further, FIG. 7C illustrates an image obtained when the matteness of the object is increased relative to the image illustrated in FIG. 6A. FIG. 7D illustrates the brightness histogram at this time.

A comparison of the brightness histograms in FIGS. 7B, 6B, and 7D reveals that these histograms differ in shape.

A skewness s indicative of this shape may be represented by Formula 7 below. In Formula 7, I(x, y denotes the brightness of a pixel at a position (x, y), m denotes the average brightness of the entire image of the object, and N denotes the number of pixels in the entire image of the object.

$$s = \frac{\sum {( I ( x , y ) - m )}^{3}}{{N ( \sqrt{\frac{\sum {( I ( x , y ) - m )}^{2}}{N}} )}^{3}} \qquad [ Formula 7 ]$$

Now, let α₁ be the image processing parameter α for glossiness, and α₂ be the image processing parameter α for matteness. In this case, Formula 6 transforms into Formula 8 below. In Formula 8, I_{B}(x, y) denotes the pixel value (in this case, the value of brightness) when the value of the skewness s in Formula 7 becomes a value that gives glossiness, and I_{M}(x, y) denotes the pixel value when the value of the skewness s in Formula 7 becomes a value that gives matteness.

I′(x,y)=α₁I_{B}(x,y)+(1−α₁)I(x,y)

I′(x,y)=α₂I_{M}(x,y)+(1−α₂)I(x,y) [Formula 8]

The shape of the brightness histogram is determined by the value of the skewness s. The larger the skewness s, the more glossy the resulting image is perceived to be, and the smaller the skewness s, the more matte the resulting image is perceived to be. The brightness histogram of an original image is controlled by using the skewness s, and I_{B}(x, y) and I_{M}(x, y) may be determined from an image having the brightness histogram.

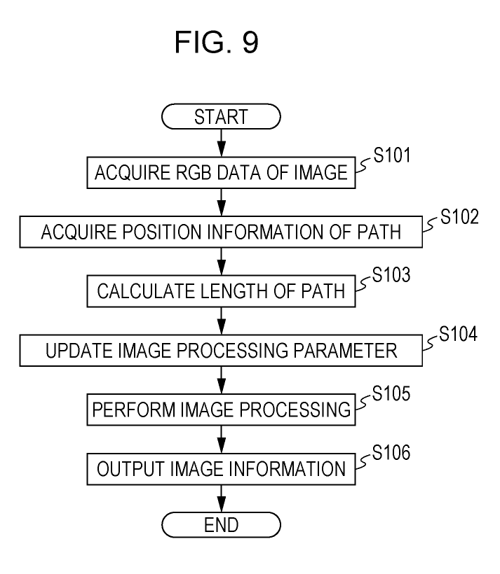

FIG. 8 illustrates a case where perception control is adjusted as image processing.

In this case, as illustrated in FIG. 8, the user inputs a path in the horizontal direction on the image G. Then, inputting a path in the rightward direction (for example, swiping on the image G from left to right) causes the image processing parameter α₂ to increase, thereby increasing the matteness of the object. Inputting a path in the leftward direction (for example, swiping on the image G from right to left) causes the image processing parameter α₁ to increase, thereby increasing the glossiness of the object.

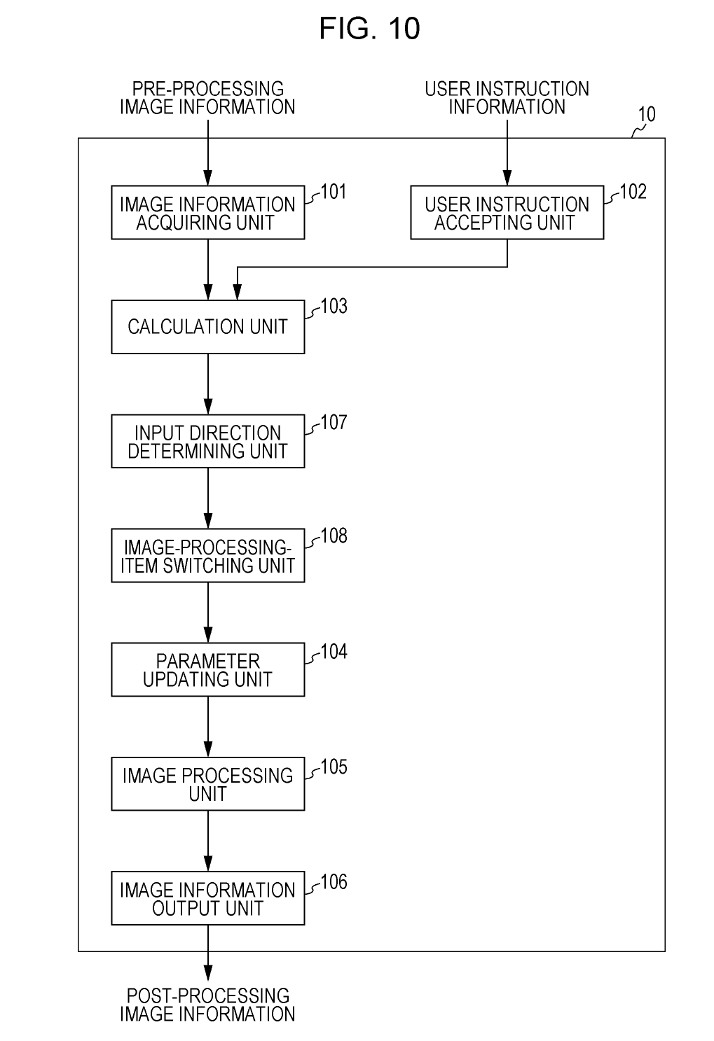

FIG. 9 is a flowchart illustrating operation of the image processing device 10 according to the first exemplary embodiment.

Hereinafter, operation of the image processing device 10 will be described with reference to FIGS. 2 and 9.

First, the image information acquiring unit 101 acquires RGB data as the image information of an image that is subjected to image processing (step 101). This RGB data is sent to the display 20, and a pre-processing image is displayed on the display 20.

Next, with respect to the image displayed on the display screen 21 of the display 20, the user inputs a path by, for example, the method described above with reference to FIG. 3 or FIG. 8. Position information of this path is acquired by the user instruction accepting unit 102 as user instruction information (step 102).

Next, the calculation unit 103 calculates the length of the path from the position information of the path by, for example, the method described above with reference to FIG. 4 (step 103).

Then, the parameter updating unit 104 updates an image processing parameter related to an item of image processing provided in advance by using, for example, Formula 3 (step 104).

Further, the image processing unit 105 performs image processing with respect to the image on the basis of the updated image processing parameter (step 105).

Then, the image information output unit 106 outputs post-processing image information (step 106). This image information is RGB data. This RGB data is sent to the display 20, and a post-processing image is displayed on the display screen 21.

### Second Exemplary Embodiment

Next, a second exemplary embodiment of the image processing device 10 will be described.

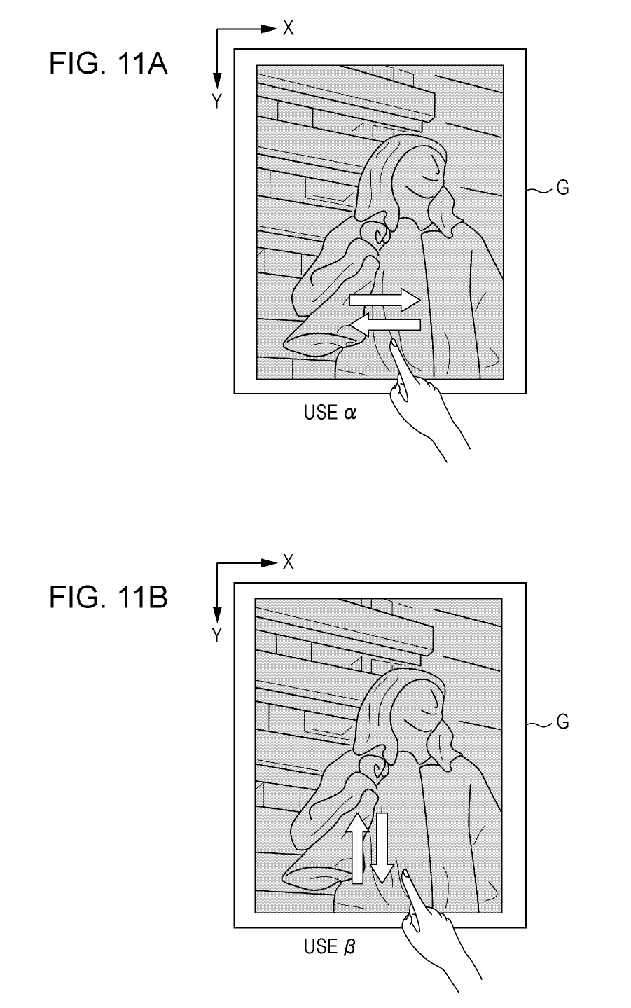

FIG. 10 is a block diagram illustrating an example of the functional configuration of the image processing device 10 according to a second exemplary embodiment of the invention.

As illustrated in FIG. 10, the image processing device 10 according to the second exemplary embodiment includes the image information acquiring unit 101, the user instruction accepting unit 102, the calculation unit 103, an input direction determining unit 107, an image-processing-item switching unit 108, the parameter updating unit 104, the image processing unit 105, and the image information output unit 106.

The image processing device 10 according to the second exemplary embodiment illustrated in FIG. 10 differs from the image processing device 10 according to the first exemplary embodiment illustrated in FIG. 2 in that the input direction determining unit 107 and the image-processing-item switching unit 108 are further provided.

The image information acquiring unit 101 and the user instruction accepting unit 102 have the same functions as in the first exemplary embodiment. Since the same also applies to the image information output unit 106, the following description will be directed to other functional units.

The calculation unit 103 transmits information of both the movement of a path in the X-direction |X₀−X₁|, and the movement of the path in the Y-direction |Y₀−Y₁| to the input direction determining unit 107 located in the subsequent stage.

The input direction determining unit 107 determines the input direction of the path.

Specifically, the input direction determining unit 107 compares the movement of the path in the X-direction |X₀−X₁| with the movement of the path in the Y-direction |Y₀−Y₁|. The input direction determining unit 107 determines whether the path is inputted in the X-direction or the Y-direction depending on which one of these two movements is greater.

The image-processing-item switching unit 108 switches the items of image processing to be performed in the image processing unit 105, in accordance with the input direction of the path.

While the first exemplary embodiment mentioned above supports input of a path in only one direction, the second exemplary embodiment supports input of a path in two directions, and items of image processing are switched in accordance with the input direction.

For example, in a case where the image processing unit 105 is able to perform image processing with respect to two image processing parameters, the image processing parameter α and the image processing parameter β, image processing is performed by using one of the image processing parameter α and the image processing parameter β depending on the input direction of a path. Further, the parameter updating unit 104 also updates the length of the path with respect to one of the image processing parameter α and the image processing parameter β.

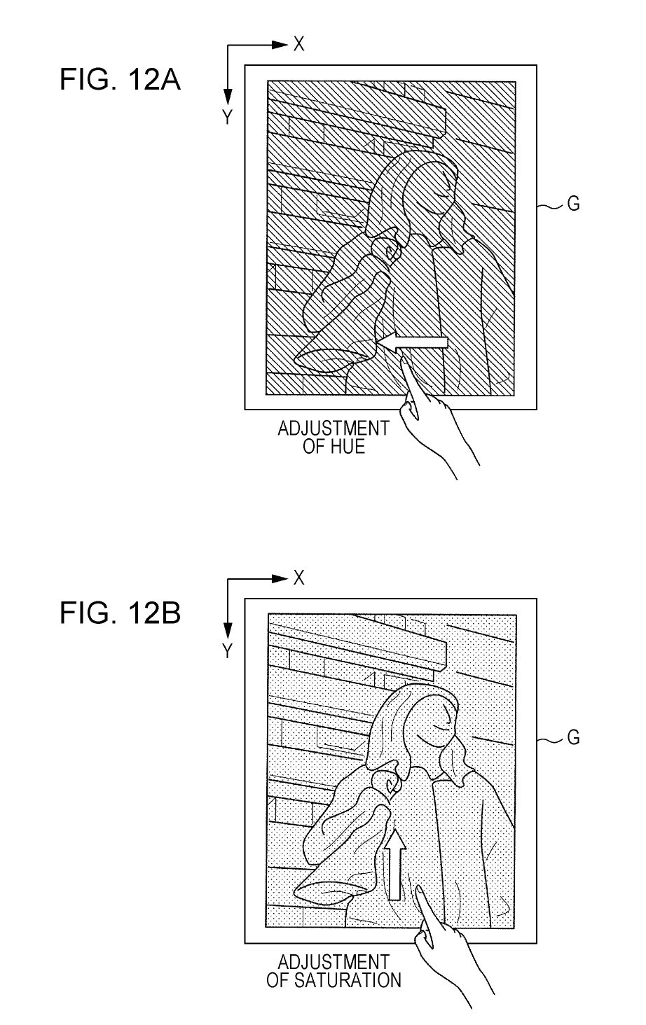

In a case where a path is inputted in the X-direction (horizontal direction) as illustrated in FIG. 11A, image processing is performed by using the image processing parameter α. Further, in a case where a path is inputted in the Y-direction (vertical direction) as illustrated in FIG. 11B, image processing is performed by using the image processing parameter β.

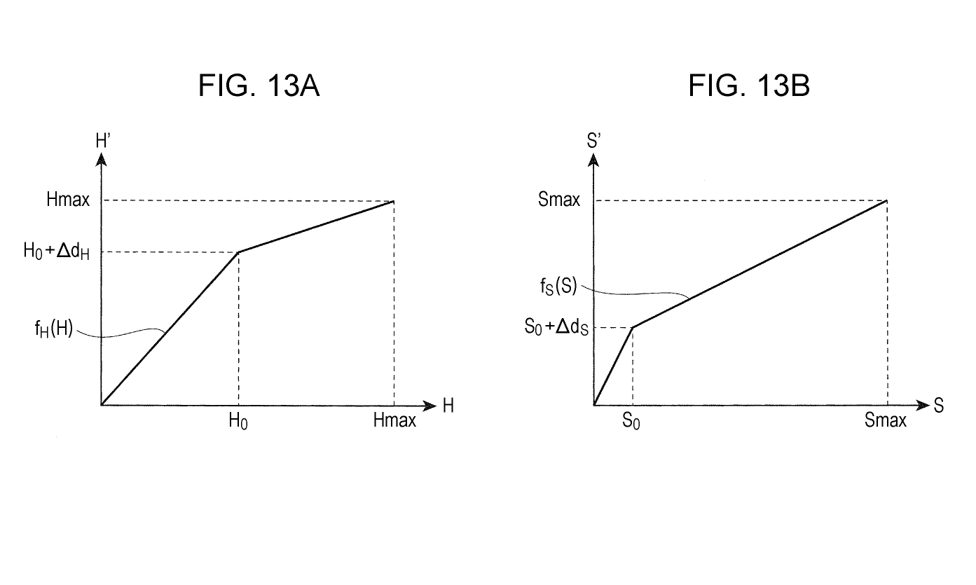

FIGS. 12A and 12B each illustrate an example of an adopted image processing parameter.

FIGS. 12A and 12B illustrate a case where adjustment of chromaticity is performed as image processing with respect to the image G. Of these figures, FIG. 12A demonstrates that hue is adjusted in a case where a path is inputted in the horizontal direction. That is, hue (H) is adopted as the image processing parameter α. Further, FIG. 12B demonstrates that saturation is adjusted in a case where a path is inputted in the vertical direction. That is, saturation (S) is adopted as the image processing parameter β.

In a case where the pixel value of a pixel in the image G is represented by HSV data of H (hue), S (saturation), and V (brightness), letting the pixel value before adjustment be H, S, V, and the pixel value after adjustment be H′, S′, V′, the relationship between H and H′, and the relationship between S and S′ are represented by Formula 9 below.

H′=H+k_{H}(X₀−X₁)

S′=S+k_{S}(Y₀−Y₁) [Formula 9]

In Formula 9, k_{H} and k_{S} are proportionality constants. k_{H} denotes the degree to which the length of a path inputted in the horizontal direction is reflected on the change of H (hue), and k_{S} denotes the degree to which the length of a path inputted in the vertical direction is reflected on the change of S (saturation). That is, setting K_{H} or K_{S} to be smaller causes the sensitivity of change of H (hue) or S (saturation) to be more suppressed, and setting K_{H} or K_{S} to be larger causes the sensitivity of change of H (hue) or S (saturation) to be more improved.

According to Formula 9, the length of an inputted path is all reflected on the change in the pixel value of H (hue) or S (saturation). However, this is not to be construed restrictively.

For example, by taking the average value of H (hue) or S (saturation) for the entire image into consideration, the amount of change may be made larger for pixels having pixel values that are in the neighborhood of the average value, and the amount of change may be made smaller (or made zero) for pixels having pixel values that are far from the average value. Depending on the image, this may result in a more natural color tone than may be obtained by adjusting H (hue) or S (saturation) uniformly.

In this case, letting the pixel value before adjustment be H, S, V, and the pixel value after adjustment be H′, S′, V′, the relationship between H and H′, and the relationship between S and S′ are represented by Formula 10 below.

H′=ƒH(H)

S′=ƒ_{S}(S) [Formula 10]

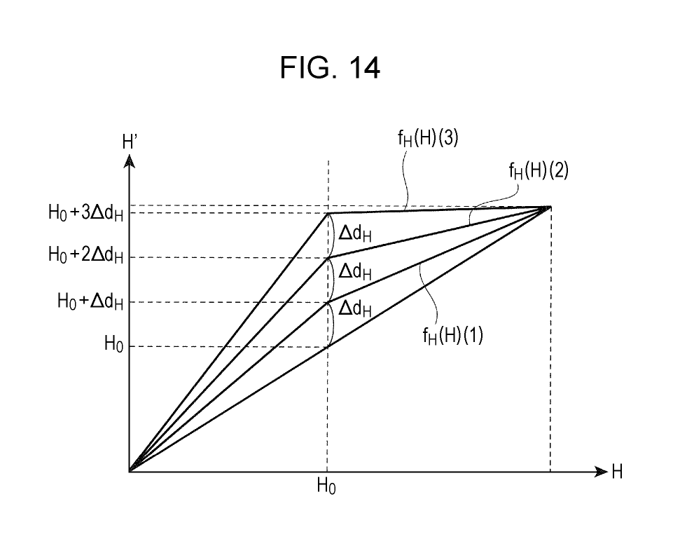

In Formula 10, functions f_{H}(H) and f_{S}(S) may be defined as functions illustrated in FIGS. 13A and 13B, respectively.

Of these figures, FIG. 13A illustrates the functions f_{H}(H). In FIG. 13A, the horizontal axis represents the pixel value before adjustment (hereinafter also referred to as pre-adjustment pixel value) H, and the vertical axis represents the pixel value after adjustment (hereinafter also referred to as post-adjustment pixel value) H′.

In the function illustrated in FIG. 13A, the amount of change of H becomes greatest in a case where the pre-adjustment pixel value is equal to the average value H₀. Further, the function f_{H}(H) is defined by a line connecting the coordinates (H₀, H₀+Δd_{H}) represented by the average value H₀ and the pixel value H₀+Δd_{H} obtained after color adjustment, and the coordinates (Hmax, Hmax) represented by the maximum value Hmax of H or Hₕ, and a line connecting the coordinates (H₀, H₀+Δd_{H}) and the origin (0, 0).

Likewise, FIG. 13B illustrates the functions f_{S}(S). In FIG. 13B, the horizontal axis represents the pre-adjustment pixel value S, and the vertical axis represents the post-adjustment pixel value S′.

In the function illustrated in FIG. 13B, the amount of change of S becomes greatest in a case where the pre-adjustment pixel value is equal to the average value S₀. Further, the function f_{S}(S) is defined by a line connecting the coordinates (S₀, S₀+Δd_{S}) represented by the average value S₀ and the pixel value S₀+Δd_{S} obtained after color adjustment, and the coordinates (Smax, Smax) represented by the maximum value Smax of S or Sₕ, and a line connecting the coordinates (S₀, S₀+Δd_{S}) and the origin (0, 0).

The amount of change Δd_{H} of H, and the amount of change Δd_{S} of S at this time are represented by Formula 11 below.

Δd_{H}=k_{H}(X₀−X₁)

Δd_{S}=k_{S}(Y₀−Y₁) [Formula 11]

When a path is inputted in the same direction multiple times, the functions f_{H}(H) and f_{S}(S) are sequentially updated.

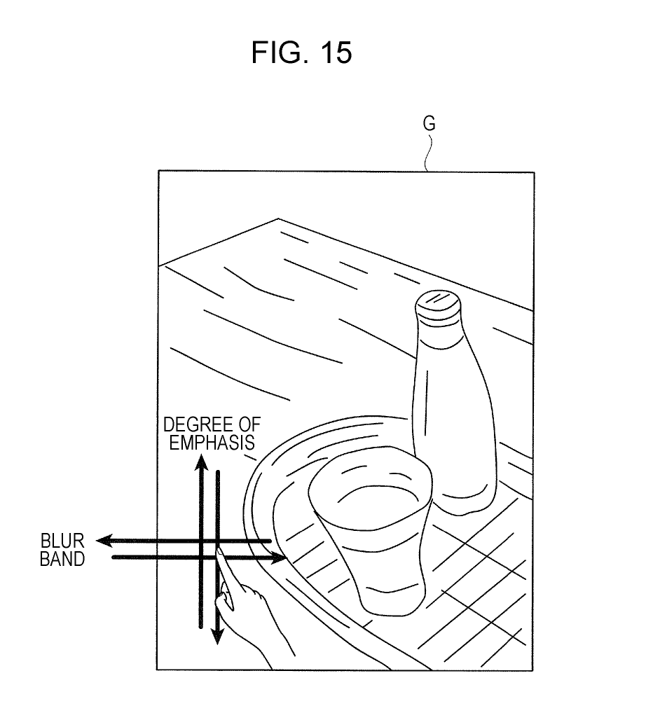

FIG. 14 illustrates how the function f_{H}(H) is updated when a path in the vertical direction is inputted multiple times.

When a path in the vertical direction is inputted once, at the point of the average value H₀, the amount of change of H is Δd_{H}, and the pixel value obtained after color adjustment becomes H₀+Δd_{H}. The resulting function f_{H}(H) is the same function as in FIG. 13A. In FIG. 14, this function is depicted as f_{H}(H)(1). When a path in the vertical direction is inputted once more, at the point of the average value H₀, H further changes by Δd_{H}, resulting in the pixel value after color adjustment of H₀+2Δd_{H}. Accordingly, the function f_{H}(H) is updated to a function depicted as f_{H}(H)(2). When a path in the vertical direction is further inputted once more, at the point of the average value H₀, H further changes by Δd_{H}, resulting in the pixel value after color adjustment of H₀+3Δd_{H}. Accordingly, the function f_{H}(H) is updated to a function depicted as f_{H}(H)(3). At this time, it is desirable to set a limit that places an upper bound on how much the function f_{H}(H) may be updated, so that the function f_{H}(H) is not updated beyond this limit.

In the above-mentioned example, H (hue) and S (saturation) are adjusted in accordance with the input direction of a path. However, this is not to be construed restrictively. For example, the combination may be that of H (hue) and V (brightness), or further, S (saturation) and V (brightness). Furthermore, the image processing parameters to be associated with each input direction of a path are not limited to these but may be other parameters.

In the above-mentioned example, it is desirable to perform image processing after converting RGB data acquired by the image information acquiring unit 101 into HSV data. However, this is not to be construed restrictively. Image processing may be performed after converting the RGB data into L*a*b* data or YCbCr data, or by using the RGB data as it is.

It is also conceivable to perform image processing by setting parameters that take note of the spatial frequency of an image as image processing parameters.

Specifically, the brightness V of each pixel value is adjusted by using Formula 12 below. In Formula 12, α_{g} denotes a parameter indicating the degree of emphasis, and α_{B} denotes a parameter indicating the blur band.

In this case, V−V_{B}(α_{B}) denotes an unsharp component. Further, V_{B} denotes a smoothed image. A small value of α_{B} results in an image with a small degree of blur, and a large value of α_{B} results in an image with a large degree of blur. Consequently, in a case where α_{B} is small, the unsharp component V−V_{B}(α_{B}) has a higher frequency, causing Formula 12 to become a formula for emphasizing higher frequencies so that fine edges (details) are reproduced clearly. To the contrary, in a case where α_{B} is large, the unsharp component V−V_{B}(α_{B}) has a lower frequency, causing Formula 12 to become a formula for emphasizing lower frequencies so that rough edges (shapes) are emphasized. Because α_{g} represents a degree of emphasis (gain), a small value of α_{g} results in a small degree of emphasis, and a large value of α_{g} results in a large degree of emphasis.

V′=V+α_{g}(V−V_{B}(α_{B})) [Formula 12]

In this case, for example, in a case where a path is inputted in the horizontal direction, this causes the parameter α_{B} indicating the blur band to increase or decrease, and in a case where a path is inputted in the vertical direction, this causes the parameter α_{g} indicating the degree of emphasis to increase or decrease.

Further, at this time, the amount of change Δα_{B} of α_{B}, and the amount of change Δα_{g} of α_{g} are represented by Formula 13 below.

Δα_{B}=k_{B}(X₀−X₁)

Δα_{g}=k_{g}(Y₀−Y₁) [Formula 13]

In Formula 13, k_{B} and k_{g} are proportionality constants. k_{B} indicates the degree to which the length of a path inputted in the horizontal direction is reflected on the change of the parameter α_{B} indicating the blur band, and k_{g} indicates the degree to which the length of a path inputted in the vertical direction is reflected on the change of the parameter α_{g} indicating the degree of emphasis.

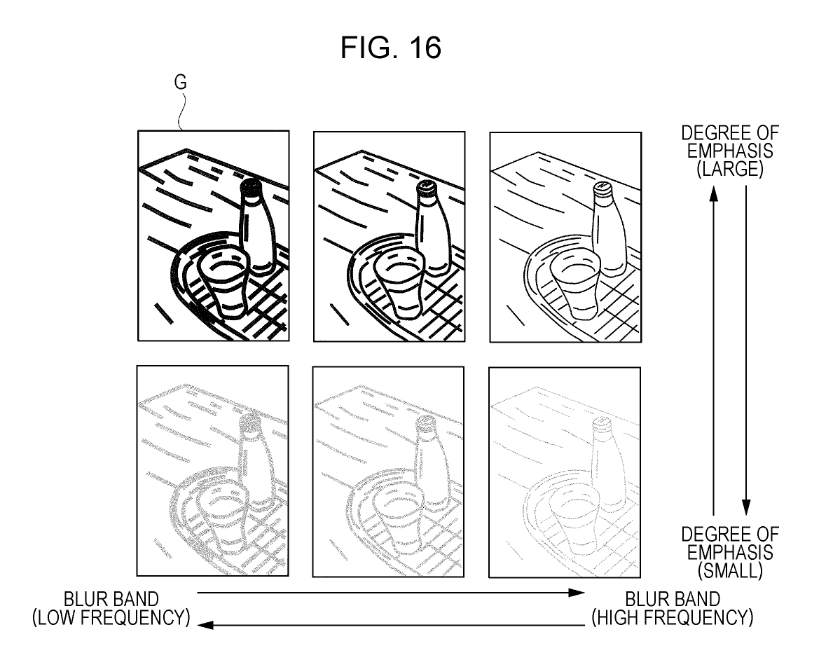

FIG. 15 illustrates an example of the image G displayed on the display screen 21 when adjusting spatial frequency.

When the user inputs a path in the horizontal direction, this adjusts the parameter α_{B} indicating the blur band. That is, when the user inputs a path in the rightward direction, this shifts the parameter α_{B} indicating the blur band toward higher frequencies. When the user inputs a path in the leftward direction, this shifts the parameter α_{B} indicating the blur band toward lower frequencies.

When the user inputs a path in the vertical direction, this adjusts the parameter α_{g} indicating the degree of emphasis. That is, when the user inputs a path in the upward direction, this increases the parameter α_{g} indicating the degree of emphasis. When the user inputs a path in the downward direction, this decreases the parameter α_{g} indicating the degree of emphasis.

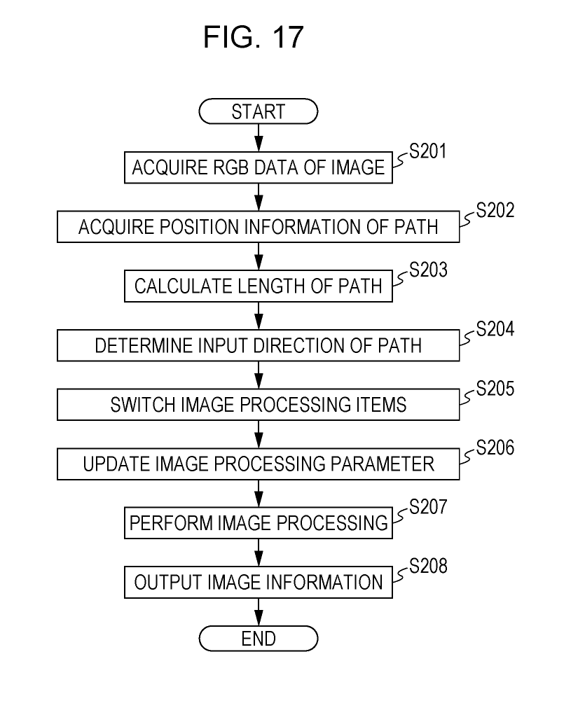

FIG. 16 illustrates the image G obtained after image processing is performed as a result of the operation illustrated in FIG. 15.

As illustrated in FIG. 16, when the parameter α_{B} indicating the blur band is adjusted, and the blur band α_{B} is shifted toward higher frequencies (rightward direction in FIG. 16), the resulting image G becomes sharper, and when the parameter α_{B} indicating the blur band is shifted toward lower frequencies (leftward direction in FIG. 16), the resulting image G becomes more unsharp.

When the parameter α_{g} indicating the degree of emphasis is adjusted so as to increase (upward direction in FIG. 16), the resulting image G is displayed as a more emphasized image, and when the parameter α_{g} indicating the degree of emphasis is decreased (downward direction in FIG. 16), the resulting image G is displayed as a less emphasized image.

While there are various methods for blurring an image, including a method using a Gaussian filter, a method using a moving average, and a method of reducing and then enlarging an image, any method may be used. For example, in the case of the method using a Gaussian filter, the parameter α_{B} indicating the blur band may be associated with the variance of a Gaussian function. In the case of the method using a moving average, the parameter α_{B} may be associated with the size of a moving window. In the case of the method of reducing and then enlarging an image, the parameter α_{B} may be associated with the reduction ratio.

With regard to the parameter α_{B} indicating the blur band and the parameter α_{g} indicating the degree of emphasis, it is desirable to set a limit that places an upper bound on how much these parameters may be updated, so that these parameters are not updated beyond this limit.

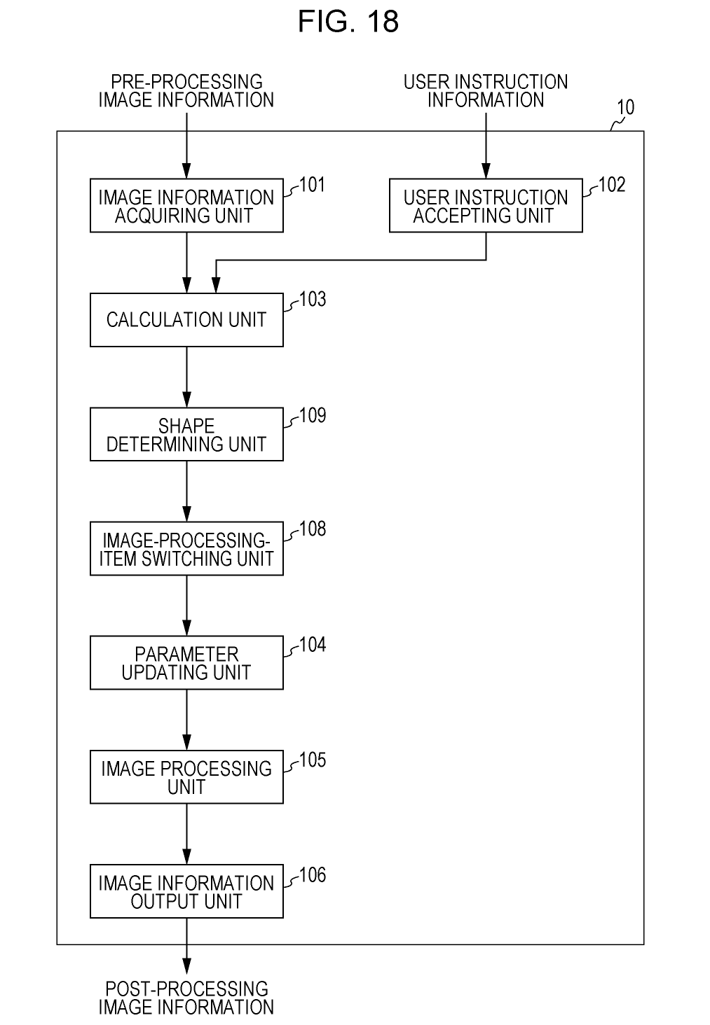

FIG. 17 is a flowchart illustrating operation of the image processing device 10 according to the second exemplary embodiment.

Hereinafter, operation of the image processing device 10 will be described with reference to FIGS. 10 and 17.

First, the image information acquiring unit 101 acquires RGB data as the image information of an image that is subjected to image processing (step 201). This RGB data is sent to the display 20, and a pre-processing image is displayed on the display 20.

Next, with respect to the image displayed on the display screen 21 of the display 20, the user inputs a path by, for example, the method described above with reference to FIGS. 12A and 12B. Position information of this path is acquired by the user instruction accepting unit 102 as user instruction information (step 202).

Next, the calculation unit 103 calculates the length of the path from the position information of the path (step 203).

Then, the input direction determining unit 107 determines the input direction of the path (step 204).

Further, the image-processing-item switching unit 108 switches the items of image processing to be performed in the image processing unit 105, in accordance with the input direction of the path (step 205).

Next, the parameter updating unit 104 updates an image processing parameter related to the switched item of image processing (step 206).

Further, the image processing unit 105 performs image processing with respect to the image on the basis of the updated image processing parameter (step 207).

Next, the image information output unit 106 outputs post-processing image information (step 208). This image information is sent to the display 20, and a post-processing image is displayed on the display screen 21.

### Third Exemplary Embodiment

Next, a third exemplary embodiment of the image processing device 10 will be described.

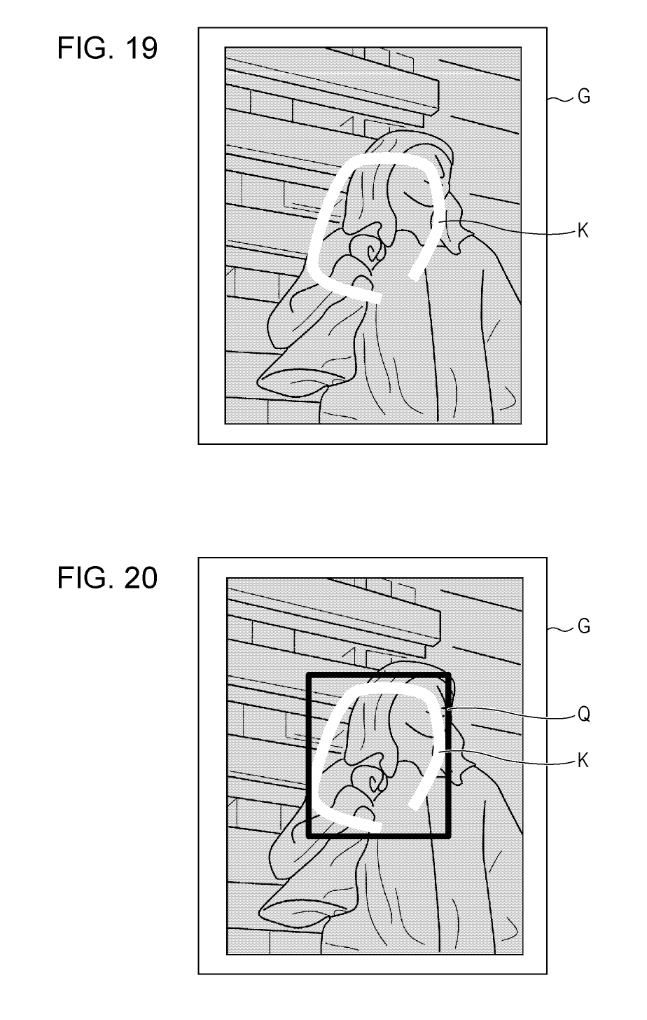

FIG. 18 is a block diagram illustrating an example of the functional configuration of the image processing device 10 according to the third exemplary embodiment of the invention.

As illustrated in FIG. 18, the image processing device 10 according to the second exemplary embodiment includes the image information acquiring unit 101, the user instruction accepting unit 102, the calculation unit 103, a shape determining unit 109, the image-processing-item switching unit 108, the parameter updating unit 104, the image processing unit 105, and the image information output unit 106.

The image processing device 10 according to the third exemplary embodiment illustrated in FIG. 18 differs from the image processing device 10 according to the first exemplary embodiment illustrated in FIG. 2 in that the shape determining unit 109 and the image-processing-item switching unit 108 are further provided.

The image information acquiring unit 101 and the user instruction accepting unit 102 have the same functions as in the first exemplary embodiment. Since the same also applies to the image information output unit 106, the following description will be directed to other functional units.

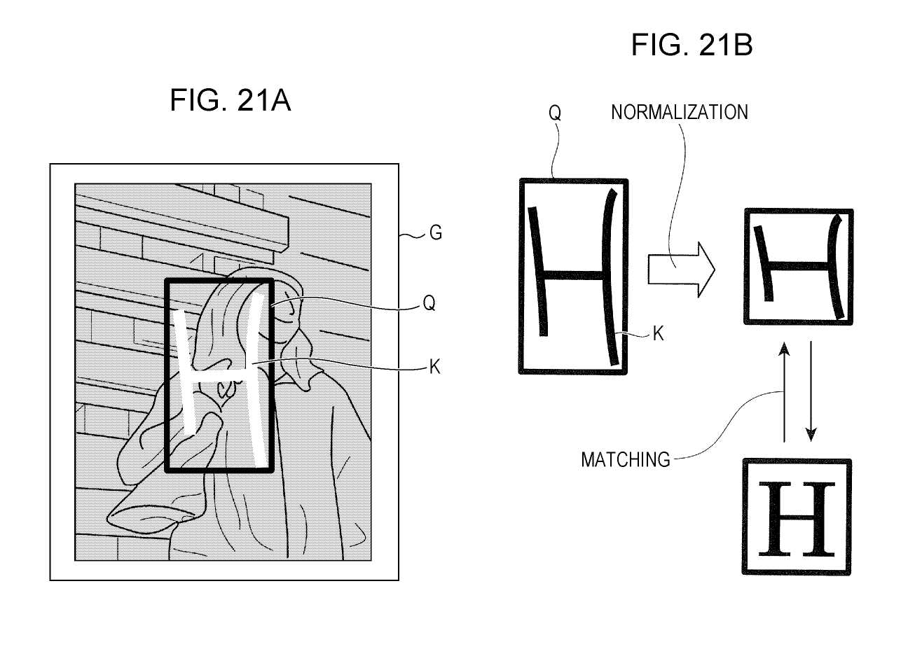

FIG. 19 illustrates an example of a path inputted by the user according to the third exemplary embodiment.

While a linear path is inputted in the first exemplary embodiment and the second exemplary embodiment mentioned above, a predetermined geometrical figure or a character is inputted as a path. In the example illustrated in FIG. 19, the user inputs the geometrical figure “◯” that is a circle as such a geometrical figure.

The calculation unit 103 calculates the size of the path as the magnitude of the path.

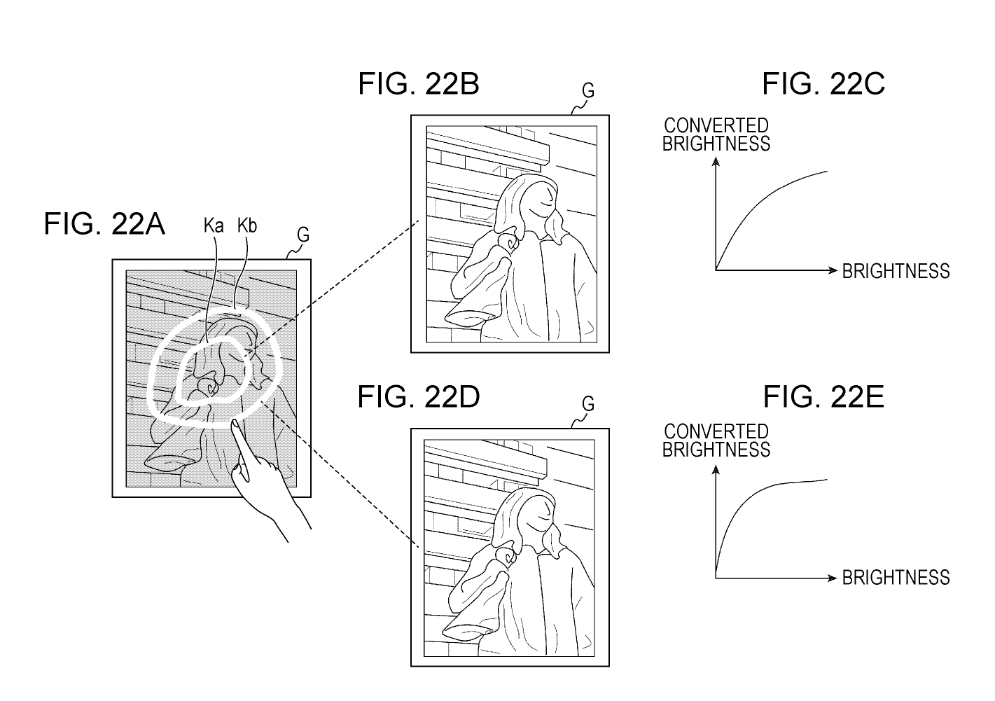

FIG. 20 illustrates an example of a method of calculating the size of a path K.

As illustrated in FIG. 20, a rectangle Q circumscribing the path K that is the geometrical figure “◯” is considered, and the size of the path is calculated on the basis of this rectangle Q.

Specifically, for example, the length of the long side of the rectangle Q may be determined as the size of the path K. Alternatively, the average of the length of the long side of the rectangle Q and the length of its short side may be determined as the size of the path K. This size of the path K is calculated by the calculation unit 103.

The shape determining unit 109 determines the shape of the inputted path.

That is, the shape determining unit 109 determines the shape of the path K. From the determined shape, the shape determining unit 109 determines which one of the items of image processing performed in the image processing unit 105 the determined shape corresponds to.

In this example, in a case where the shape of the path K is the geometrical figure “◯” that is a circle, gamma correction of brightness is performed as image processing. Further, in a case where the shape of the path K is the character “H”, hue adjustment is performed as image processing, and in a case where the shape of the path K is the character “S”, saturation adjustment is performed as image processing.

The shape of the path K is determined as follows, for example.

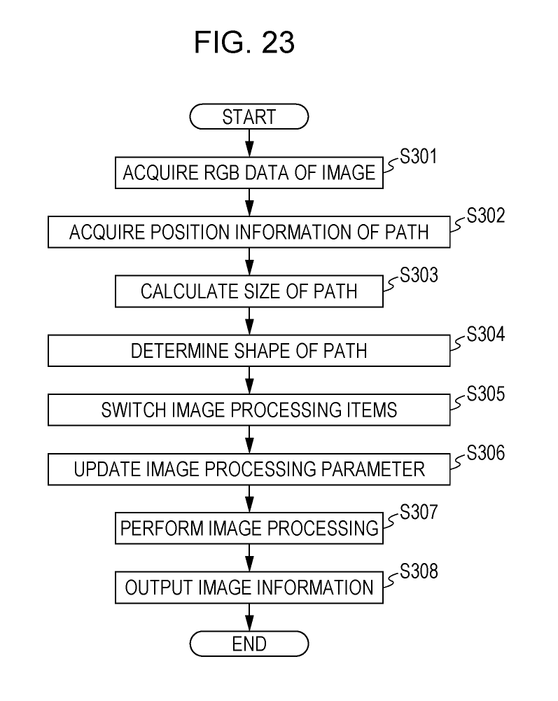

FIGS. 21A and 21B illustrate a method of determining the shape of the path K.

FIG. 21A illustrates a rectangle Q circumscribing the path K in a case where the character “H” is inputted as the path K. As illustrated in FIG. 21B, the rectangle Q is normalized into a square together with the path K inside the rectangle Q. Then, with respect to the normalized geometrical figure or character, matching is performed against a geographical figure, a character, or the like serving as a template provided in advance, and the shape of the path K is determined on the basis of similarity to the template.

The image-processing-item switching unit 108 switches the items of image processing to be performed in the image processing unit 105, in accordance with the shape of the path.

Then, the parameter updating unit 104 updates an image processing parameter related to the switched item of image processing. At this time, the degree to which the image processing parameter is updated varies with the size of the path K. That is, the larger the size of the path K, the more the image processing parameter is changed.

The image processing unit 105 performs image processing with respect to the image on the basis of the updated image processing parameter.

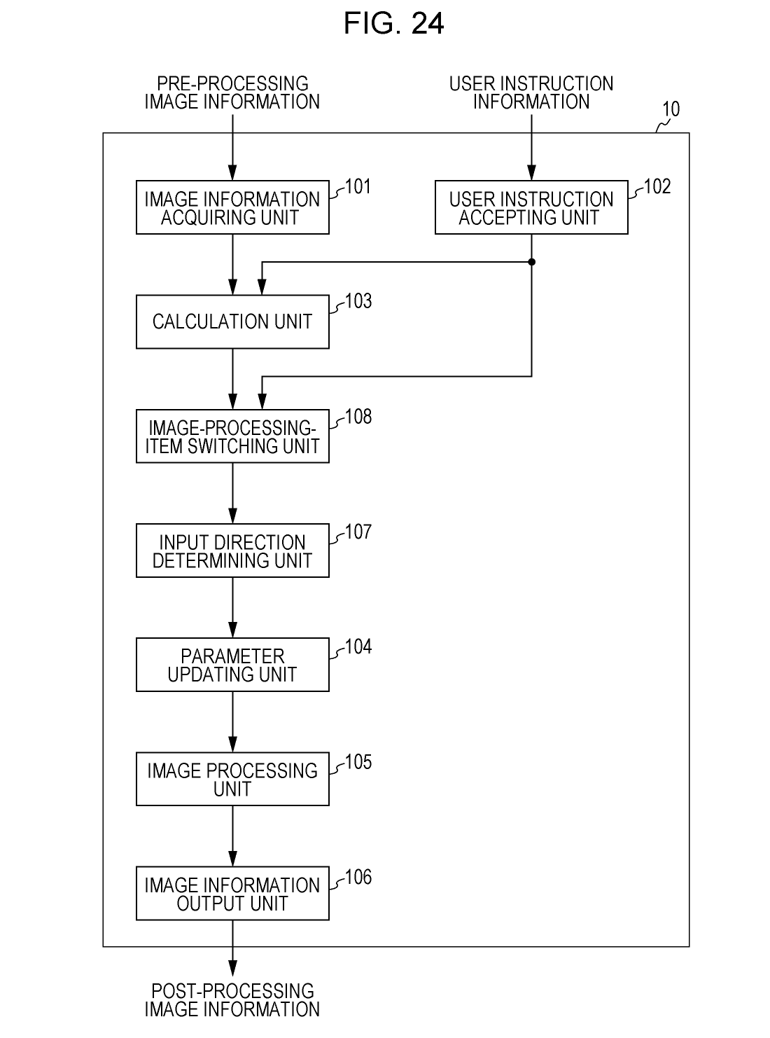

FIGS. 22A to 22E illustrate how the results of image processing differ depending on the size of the path K.

FIG. 22A illustrates the path K that is inputted. At this time, when a path Ka that is the geometrical figure “◯” with a smaller size is inputted, gamma correction of brightness is performed as illustrated in FIG. 22C, and the corresponding image is displayed as illustrated in FIG. 22B.

When a path Kb that is the geometrical figure “◯” with a larger size is inputted at this time, gamma correction of brightness is performed as illustrated in FIG. 22E, and the corresponding image is displayed as illustrated in FIG. 22D.

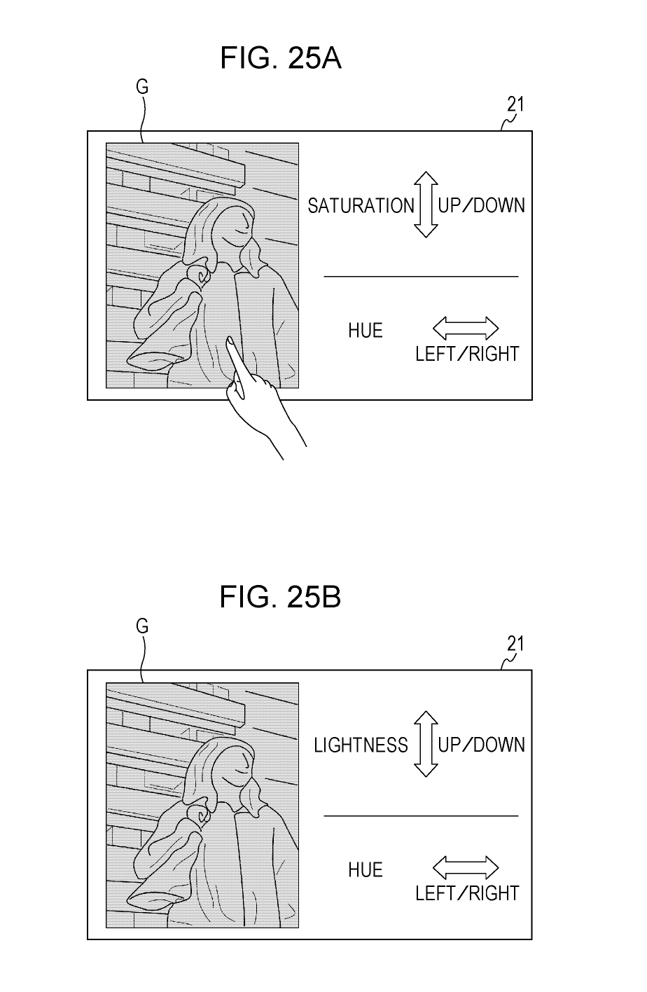

FIG. 23 is a flowchart illustrating operation of the image processing device 10 according to the third exemplary embodiment.

Hereinafter, operation of the image processing device 10 will be described with reference to FIGS. 18 and 23.

First, the image information acquiring unit 101 acquires RGB data as the image information of an image that is subjected to image processing (step 301). This RGB data is sent to the display 20, and a pre-processing image is displayed on the display 20.

Next, with respect to the image displayed on the display screen 21 of the display 20, the user inputs a path by, for example, the method described above with reference to FIG. 19. Position information of this path is acquired by the user instruction accepting unit 102 as user instruction information (step 302).

Next, as described above with reference to FIG. 20, the calculation unit 103 calculates a rectangle circumscribing the path from the position information of the path, and calculates the size of the path on the basis of this rectangle (step 303).

Further, the shape determining unit 109 determines the shape of the path (step 304).

Then, the image-processing-item switching unit 108 switches items of image processing in accordance with the shape of the path (step 305).

Next, the parameter updating unit 104 updates an image processing parameter related to the switched item of image processing (step 306).

Further, the image processing unit 105 performs image processing with respect to the image on the basis of the updated image processing parameter (step 307).

Next, the image information output unit 106 outputs post-processing image information (step 308). This image information is sent to the display 20, and a post-processing image is displayed on the display screen 21.

### Fourth Exemplary Embodiment

Next, a fourth exemplary embodiment of the image processing device 10 will be described.

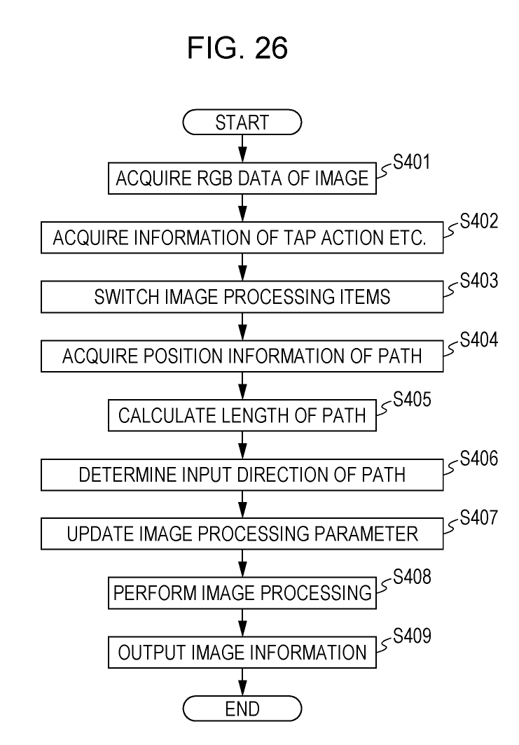

FIG. 24 is a block diagram illustrating an example of the functional configuration of the image processing device 10 according to the fourth exemplary embodiment of the invention.

As illustrated in FIG. 24, the image processing device 10 according to the second exemplary embodiment includes the image information acquiring unit 101, the user instruction accepting unit 102, the image-processing-item switching unit 108, the input direction determining unit 107, the calculation unit 103, the parameter updating unit 104, the image processing unit 105, and the image information output unit 106.

The image processing device 10 according to the fourth exemplary embodiment illustrated in FIG. 24 differs from the image processing device 10 according to the second exemplary embodiment illustrated in FIG. 10 in that the input direction determining unit 107 and the image-processing-item switching unit 108 are reversed.

In the fourth exemplary embodiment, in the image-processing-item switching unit 108, items of image processing are switched by a tap action or a clock action performed by the user on the display screen 21. Information of this tap action or click action is acquired by the user instruction accepting unit 102 as user instruction information. The image-processing-item switching unit 108 switches items of image processing on the basis of this user instruction information.

For example, in a case where there are n image processing parameters α₁, α₂, α₃, . . . , and αₙ, the image processing parameters may be switched sequentially in the manner of α₁→α₂→α₃ . . . →αₙ→α₁, in response to a tap action or click action. In a case where there are three image processing parameters α₁, α₂, and α₃, combinations of two of these parameters, α₁α₂, α₂α₃, and α₃α₁ may be switched sequentially in the manner of α₁α₂→α₂α₃→α₃α₁→α₁α₂.

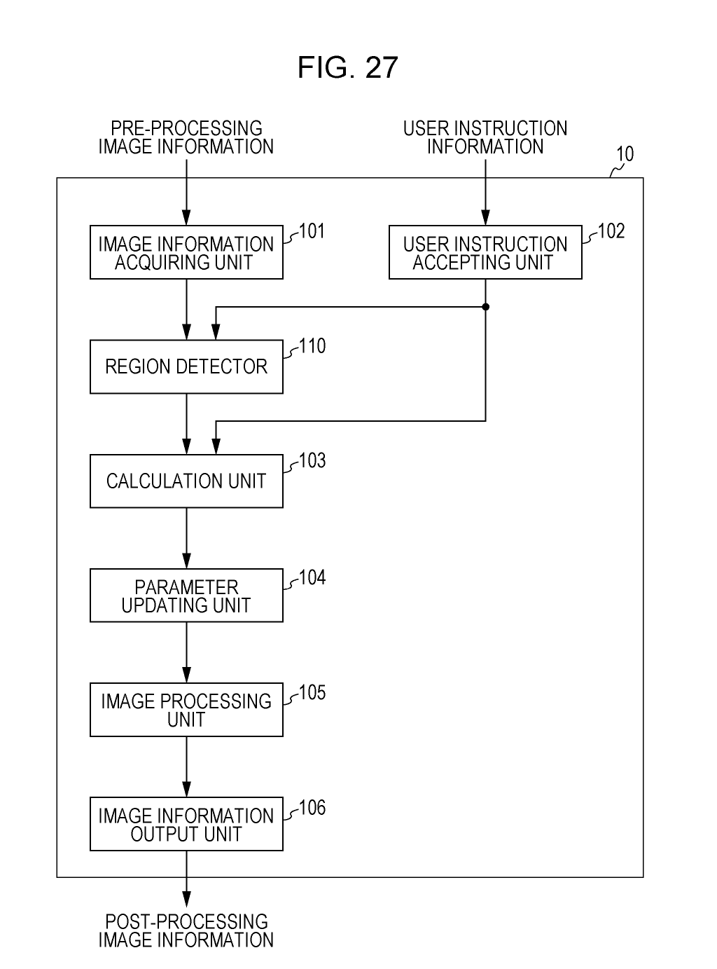

FIGS. 25A and 25B each illustrate an example of an image displayed on the display screen 21 when switching items of image processing.

FIGS. 25A and 25B illustrate a case where the items to be adjusted are switched by a tap action. That is, in a case where the input device 30 is a touch panel, by tapping any location on the display screen 21, the items to be adjusted are switched alternately between “saturation” and “hue” illustrated in FIG. 25A, and “lightness” and “hue” illustrated in FIG. 25B. In the present case, as a result of tapping the screen illustrated in FIG. 25A, the screen is switched to the screen illustrated in FIG. 25B.

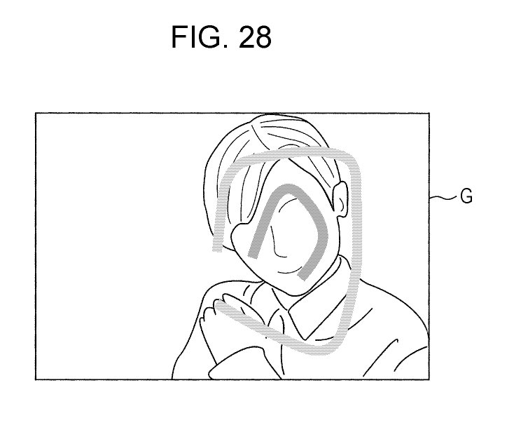

FIG. 26 is a flowchart illustrating operation of the image processing device 10 according to the fourth exemplary embodiment.

Hereinafter, operation of the image processing device 10 will be described with reference to FIGS. 24 and 26.

First, the image information acquiring unit 101 acquires RGB data as the image information of an image that is subjected to image processing (step 401). This RGB data is sent to the display 20, and a pre-processing image is displayed on the display 20.

Next, items of image processing are switched by a tap action or a clock action performed by the user on the display screen 21. Information of this tap action or click action is acquired by the user instruction accepting unit 102 as user instruction information (step 402).

Then, the image-processing-item switching unit 108 switches items of image processing in accordance with the number of times a tap action or click operation is performed by the user on the display screen 21 (step 403).

Next, the user inputs a path with respect to the image displayed on the display screen 21 of the display 20. Position information of this path is acquired by the user instruction accepting unit 102 as user instruction information (step 404).

Then, the calculation unit 103 calculates the length of the path from the position information of the path (step 405).

Then, the input direction determining unit 107 determines the input direction of the path (step 406).

Further, the parameter updating unit 104 updates an image processing parameter corresponding to the switched item of image processing and the input direction of the path (step 407).

Then, the image processing unit 105 performs image processing with respect to the image on the basis of the updated image processing parameter (step 408).

Next, the image information output unit 106 outputs post-processing image information (step 409). This image information is sent to the display 20, and a post-processing image is displayed on the display screen 21.

### Fifth Exemplary Embodiment

Next, a fifth exemplary embodiment of the image processing device 10 will be described.

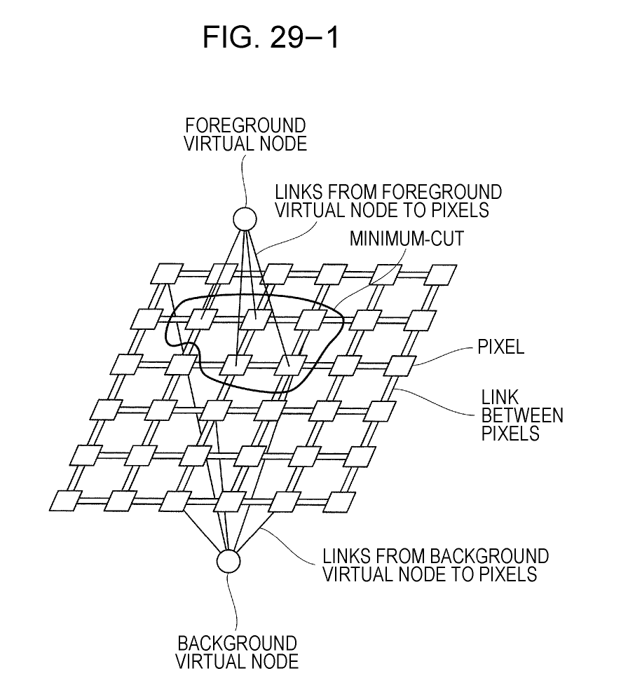

FIG. 27 is a block diagram illustrating an example of the functional configuration of the image processing device 10 according to the fifth exemplary embodiment of the invention.

As illustrated in FIG. 27, the image processing device 10 according to the fifth exemplary embodiment includes the image information acquiring unit 101, the user instruction accepting unit 102, a region detector 110, the calculation unit 103, the parameter updating unit 104, the image processing unit 105, and the image information output unit 106.

The image processing device 10 according to the fifth exemplary embodiment illustrated in FIG. 27 differs from the image processing device 10 according to the first exemplary embodiment illustrated in FIG. 2 in that the region detector 110 is further provided.

The region detector 110 detects a specified region on the basis of an instruction from the user. The specified region is a region that is specified by the user from an image displayed on the display 20, as an image region on which to perform image processing.

In actuality, the region detector 110 crops a specified region from an image displayed on the display 20.

The first to fourth exemplary embodiments mentioned above are suited for, for example, a case where adjustment is performed for the entire image, or a case where, even when an image is to be adjusted, the background of the image is not complex. As opposed to these exemplary embodiments, the fifth exemplary embodiment is effective for cases where, when the image has a complex background, it is desired to crop a particular specified region, and perform image processing with respect to the cropped specified region.

According to the fifth exemplary embodiment, a specified region may be cropped by a user-interactive method described below.

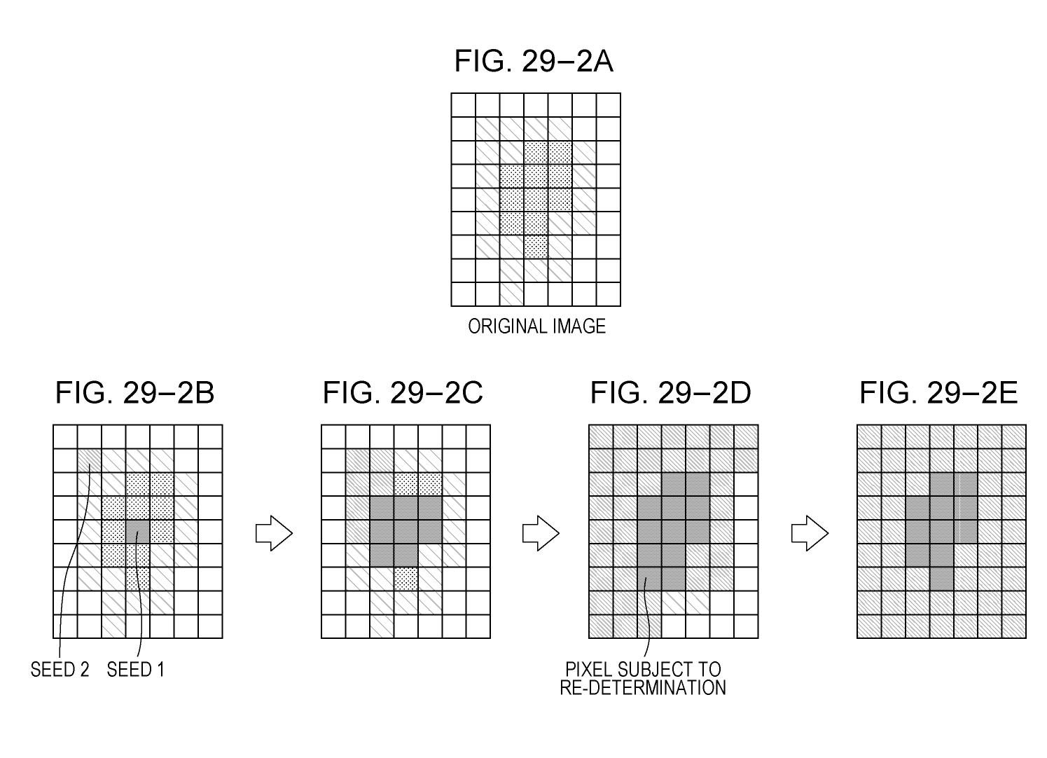

FIG. 28 illustrates an example of a method of cropping a specified region in an interactive manner.

In the illustrated example, the image being displayed on the display screen 21 of the display 20 is the image G of a photograph including a person shown as a foreground, and a background shown behind the person. In this example, the user is to crop the portion of the face of the person as a specified region.

In this case, the user gives a representative path with respect to each of the face portion and the portion other than the face (hereinafter also referred to as “non-face portion”). This path may be inputted with the input device 30. Specifically, in a case where the input device 30 is a mouse, the user draws a path by dragging the image G by operating the mouse. Likewise, in a case where the input device 30 is a touch panel, the user draws a path by performing a trace swipe on the image G with a finger, a touch pen, or the like. A point may be given instead of a path. That is, it suffices for the user to give information indicative of a representative position with respect to each of the face portion and the non-face portion.

Then, this position information is acquired by the user instruction accepting unit 102 as user instruction information. Further, a specified region is cropped by the region detector 110. In this case, the user instruction accepting unit 102 functions as a position information acquiring unit that acquires representative position information indicative of a representative position within the specified region.

Then, on the basis of the closeness of pixel values (for example, the Euclidean distance of RGB values) between pixels over which a path or the like is drawn and their neighboring pixels, the region detector 110 grows a region by repeating the process of merging pixels if their pixels values are close and not merging pixels if their pixel values are far, thereby growing a region. A specified region may be cropped by the region growing method that grows a region in this way.

Further, in order to crop a specified region, for example, a method that makes use of the principle of max-flow/min-cut may be used, with the image G being conceptualized as a graph.

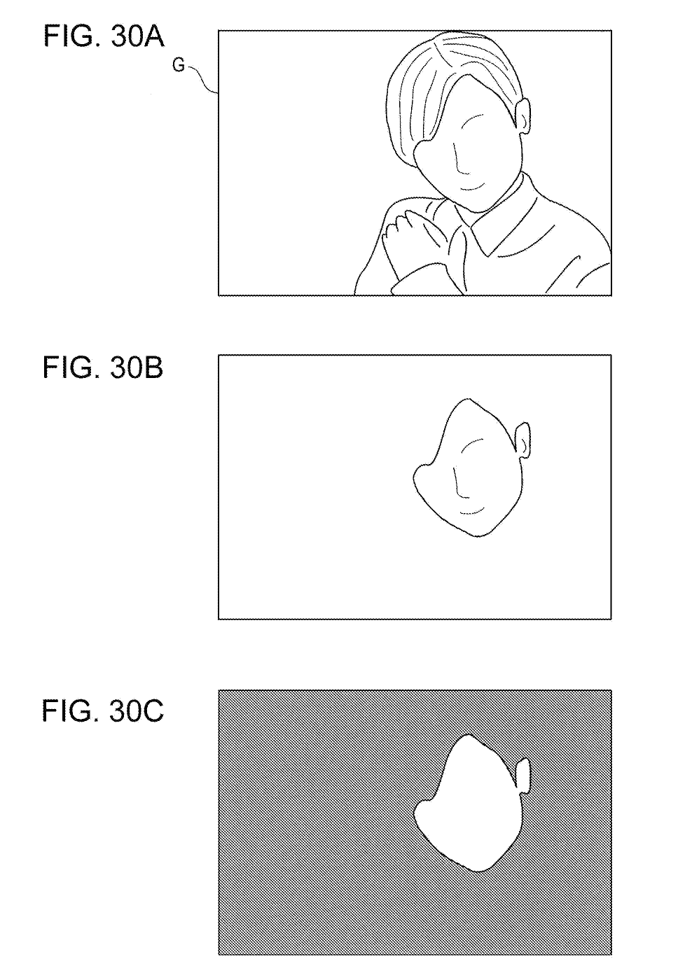

According to this principle, as illustrated in FIG. 29-1, a foreground virtual node and a background virtual node are set as a source and a sink, respectively. The foreground virtual node is linked to representative positions in the foreground region which are specified by the user, and representative positions in the background region specified by the user are linked to the sink. Then, the maximum flow that may be passed when water is passed from the source is calculated. According to the principle, the value of a link from the foreground to the source is regarded as the thickness of a water pipe, with the sum total of cuts in locations that create a bottleneck (where water is hard to flow) being equal to the maximum flow. That is, to cut bottleneck links is to separate the foreground and the background from each other (graph-cut).

Alternatively, a specified region may be cropped also by a method of using the principle of region growing after seeds are given.

FIGS. 29-2A to 29-2E illustrate a specific example of how to divide an image into two regions after two seeds are given.

In this case, for the original image illustrated in FIG. 29-2A, two seeds, Seed 1 and Seed 2, are given as illustrated in FIG. 29-2B. Then, a region is grown with each of the seeds as the starting point of growth. In this case, for example, the region may be grown in accordance with, for example, the closeness to the values of neighboring pixels in the original image. At this time, in a case where there is a competition between regions as illustrated in FIG. 29-2C, the corresponding pixels are subject to re-determination, and which region the pixels that are subject to re-determination belong to may be determined on the basis of the relationship between the pixel values of these pixels and their neighbors. At this time, the method described in the following document may be used.
V. Vezhnevets and V. Konouchine: “Grow-Cut”—Interactive Multi-label N-D Image Segmentation By Cellular Automata”, Proc. Graphicon. pp 150-156 (2005)

In the example illustrated in FIG. 29-2D, the pixels that are subject to re-determination are finally determined to belong to the region of Seed 2, and as illustrated in FIG. 29-2E, the process converges as the image is divided into two regions on the basis of the two seeds.

The above-mentioned example is related to region-cut, and is directed to a specific example of the method of cropping a region by making use of the principle of, for example, region growing or graph. However, in the fifth exemplary embodiment, the method of this region-cut is not limited, and any method may be employed.

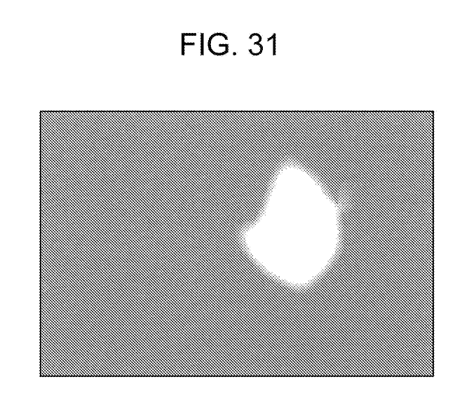

FIGS. 30A to 30C illustrate how a specified region is cropped from an original image.

FIG. 30A illustrates an image G, which is an original image before a specified region is cropped from the image. FIG. 30B illustrates a case where the portion of a person's face is cropped as a specified region. FIG. 30C illustrates the distribution of flags in a case where a flag “1” is assigned to pixels within the specified region, and a flag “0” is assigned to pixels outside the specified region. In this case, in the portion of white color, the flag is 1, indicating that this portion is the specified region. In the portion of black color, the flag is 0, indicating that this portion is outside the specified region. FIG. 30C may be seen as a mask for dividing the specified region and the outside of the specified region from each other.

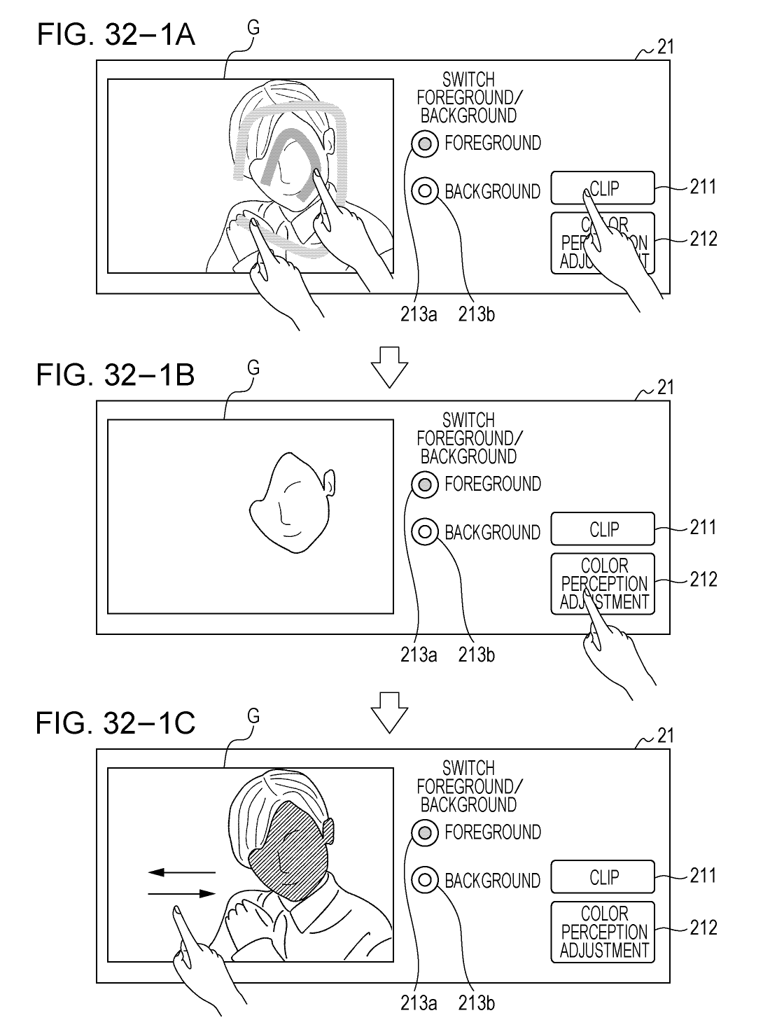

The boundary of this mask may be blurred as illustrated in FIG. 31, and this mask may be used to crop a specified region. In this case, while the mask normally has a value of 1 in the specified region and a value of 0 outside the specified region, in the vicinity of the boundary between the specified region and the outside of the specified region, the mask takes a value of 0 to 1. That is, the mask is a smoothing mask that causes the boundary between the specified region and the outside of the specified region to blur.

FIGS. 32-1A to 32-1C illustrate a case where the user crops a specified region, and further, image processing is performed thereafter.

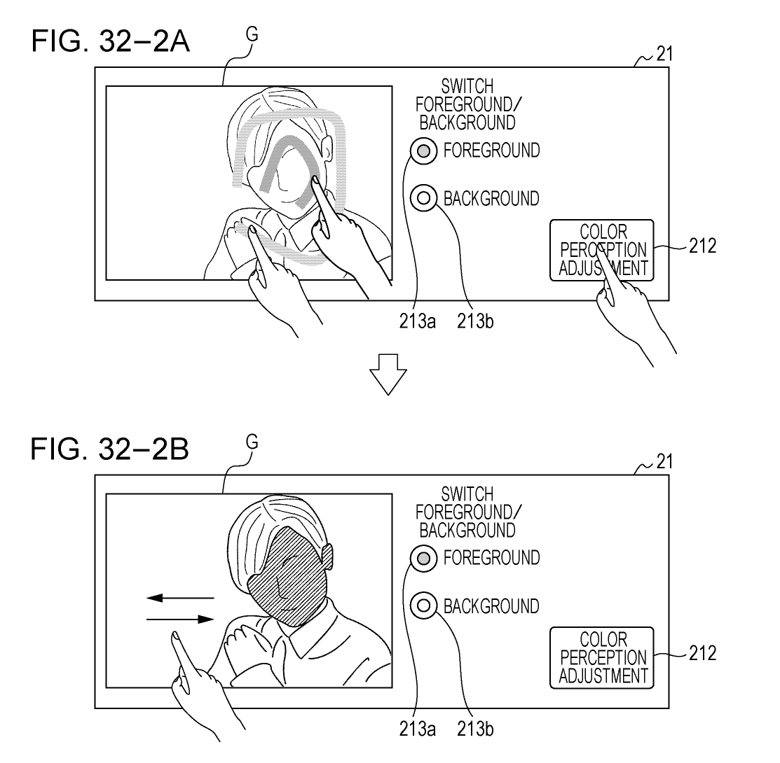

In this case, as illustrated in FIG. 32-1A, the user gives a representative path with respect to each of the portion of a face within the image G, and the non-face portion, in the manner as described above with reference to FIG. 28.

Then, as illustrated in FIG. 32-1A, when the user touches a Crop button 211, the face portion is cropped as a specified region as illustrated in FIG. 32-1B.

Further, when the user touches a Color Perception Adjustment button 212, as illustrated in FIG. 32-1C, this causes the image G to return to the original state, and the screen becomes the screen for performing image processing.

In this state, when the user performs, for example, a swipe action in the horizontal direction, for example, hue (H) is adjusted. In this case, the specified region may be switched between the face portion and the non-face portion by using a radio button 213a and a radio button 213b. In a case where the radio button 213a corresponding to “foreground” is selected, the face portion becomes the specified region, and in a case where the radio button 213b corresponding to “background” is selected, the non-face portion becomes the specified region.

FIGS. 32-2A and 32-2B illustrate a case where the Crop button 211 illustrated in FIGS. 32-1A to 32-1C is not provided.

In this case, in FIG. 32-2A, in the same manner as in FIG. 32-1A, the user gives a representative path with respect to each of a face portion and a non-face portion within the image G.

Then, when the user touches the Color Perception Adjustment button 212, as illustrated in FIG. 32-2B, the screen becomes the same screen for performing image processing as in FIG. 32-1C. That is, in this case, the Color Perception Adjustment button 212 includes the function of the Crop button 211 described above with reference to FIG. 32-1A.

Thereafter, when the user performs a swipe action, for example, hue (H) may be adjusted with respect to the specified region as in FIG. 32-1C. Further, the specified region may be switched between the face portion and the non-face portion by the radio button 213a and the radio button 213b.

Suppose that a specified region is cropped by using the mask as illustrated in FIG. 31. In this case, let w(x, y) be the value of the mask assigned to the pixel at a position (x, y) within the specified region, I_{RGB}(x, y) be the pixel value before image processing is performed, I_{RGB} (x, y) be the pixel value after image processing is performed, and I^{w}_{RGB}(x, y) be the pixel value that is masked and displayed on the screen. Then, the following relationship represented by Formula 14 below holds.

I_{RGB}^{w}(x,y)=w(x,y)I′_{RGB}(x,y)+(1−w(x,y))I_{RGB}(x,y) [Formula 14]

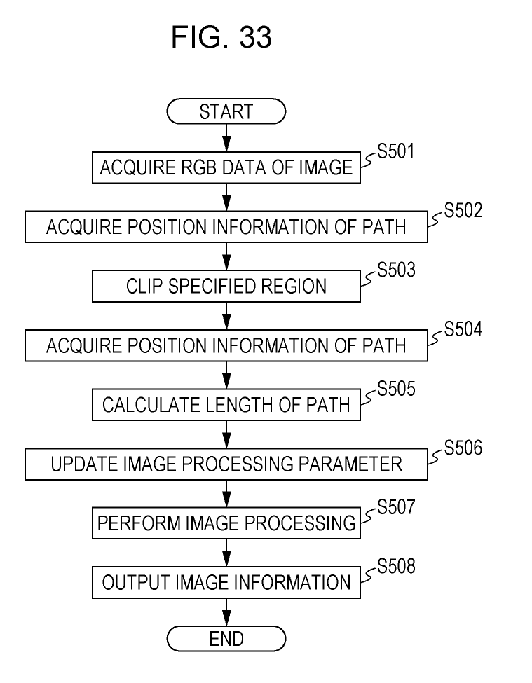

FIG. 33 is a flowchart illustrating operation of the image processing device 10 according to the fifth exemplary embodiment.

Hereinafter, operation of the image processing device 10 will be described with reference to FIGS. 27 and 33.

First, the image information acquiring unit 101 acquires RGB data as the image information of an image that is subjected to image processing (step 501). This RGB data is sent to the display 20, and a pre-processing image is displayed on the display 20.

Next, with respect to the image displayed on the display screen 21 of the display 20, the user inputs a path by, for example, the method described above with reference to FIG. 28. Position information of this path is acquired by the user instruction accepting unit 102 as user instruction information (step 502).

Then, the region detector 110 crops a specified region on the basis of the position information of this path (step 503).

Next, with respect to the image displayed on the display screen 21 of the display 20, the user inputs a path by, for example, the method described above with reference to FIG. 3 or 8. Position information of this path is acquired by the user instruction accepting unit 102 as user instruction information (step 504).

Then, the calculation unit 103 calculates the length of the path from the position information of the path by, for example, the method described above with reference to FIG. 4 (step 505).

Then, the parameter updating unit 104 updates an image processing parameter related to an item of image processing provided in advance (step 506).

Further, on the basis of the updated image processing parameter, the image processing unit 105 performs image processing with respect to the specified region within the image (step 507).

Then, the image information output unit 106 outputs post-processing image information (step 508). This image information is RGB data. This RGB data is sent to the display 20, and a post-processing image is displayed on the display screen 21.

<Hardware Configuration Example of Image Processing Apparatus>

Next, a hardware configuration of the image processing device 10 will be described.

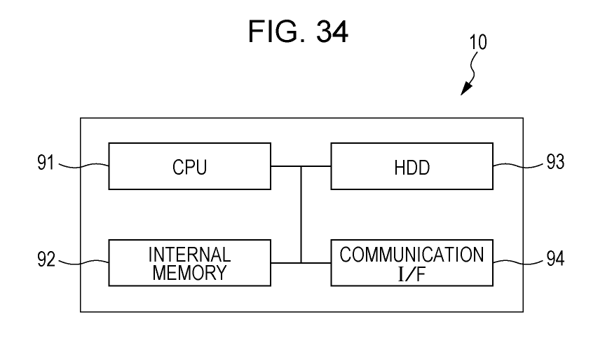

FIG. 34 illustrates a hardware configuration of the image processing device 10.

As described above, the image processing device 10 is implemented in a personal computer or the like. Further, as illustrated in FIG. 34, the image processing device 10 includes a central processing unit (CPU) 91 as an arithmetic unit, an internal memory 92 as a memory, and a hard disk drive (HDD) 93. The CPU 91 executes various programs such as an operating system (OS) and application software. The internal memory 92 is a storage area for storing various programs, and data or the like used for executing the programs. The HDD 93 is a storage area for storing data such as input data for various programs, and output data from various programs.

Further, the image processing device 10 includes a communication interface (hereinafter, referred to as “communication I/F”) 94 for communicating with the outside.

<Description of Program>

The above-described process executed by the image processing device 10 is prepared as a program such as application software, for example.

Therefore, the process executed by the image processing device 10 may be grasped as a program for causing a computer to execute the functions of: acquiring image information of an image that is subjected to image processing; acquiring position information of a path inputted by the user on the image; calculating the magnitude of the path from the position information of the path; and changing the degree to which to perform the image processing in accordance with the magnitude of the path, and performing image processing with respect to the image.

The program for implementing the embodiments may be provided not only via a communication unit but also by being stored in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing device comprising:
an image information acquiring unit that acquires image information of an image that is subjected to image processing;
a path information acquiring unit that acquires position information of a path of an operation inputted by a user on the image;
a calculation unit that calculates a magnitude of the path from the position information of the path; and
an image processing unit that changes a degree to which to perform the image processing in accordance with the magnitude of the path, and performs the image processing with respect to the image.

2. The image processing device according to claim 1, further comprising:
an input direction determining unit that determines an input direction of the path; and
an image-processing-item switching unit that switches items of the image processing performed by the image processing unit, in accordance with the input direction of the path.

3. The image processing device according to claim 1, further comprising:
a shape determining unit that determines a shape of the path; and
an image-processing-item switching unit that switches items of the image processing performed by the image processing unit, in accordance with the shape of the path.

4. The image processing device according to claim 1, further comprising an image-processing-item switching unit that switches items of the image processing by a tap action or a click action performed by the user on the image.

5. The image processing device according to claim 1, further comprising:
a position information acquiring unit that acquires representative position information to detect a specified region, the representative position information representing a representative position within the specified region, the specified region being specified by the user from the image as an image region that is subjected to image processing; and
a region detector that detects the specified region from the representative position information,
wherein the image processing unit performs the image processing with respect to the specified region.

6. The image processing device according to claim 2, further comprising:
a position information acquiring unit that acquires representative position information to detect a specified region, the representative position information representing a representative position within the specified region, the specified region being specified by the user from the image as an image region that is subjected to image processing; and
a region detector that detects the specified region from the representative position information,
wherein the image processing unit performs the image processing with respect to the specified region.

7. The image processing device according to claim 3, further comprising:
a position information acquiring unit that acquires representative position information to detect a specified region, the representative position information representing a representative position within the specified region, the specified region being specified by the user from the image as an image region that is subjected to image processing; and
a region detector that detects the specified region from the representative position information,
wherein the image processing unit performs the image processing with respect to the specified region.

8. The image processing device according to claim 4, further comprising:
a position information acquiring unit that acquires representative position information to detect a specified region, the representative position information representing a representative position within the specified region, the specified region being specified by the user from the image as an image region that is subjected to image processing; and
a region detector that detects the specified region from the representative position information,
wherein the image processing unit performs the image processing with respect to the specified region.

9. An image processing method comprising:
acquiring image information of an image that is subjected to image processing;
acquiring position information of a path of an operation inputted by a user on the image;
calculating a magnitude of the path from the position information of the path; and
changing a degree to which to perform the image processing in accordance with the magnitude of the path, and performing the image processing with respect to the image.

10. An image processing system comprising:
a display that displays an image;
an image processing device that performs image processing with respect to image information of an image displayed on the display; and
an input device that is used by a user to input an instruction for performing the image processing to the image processing device,
wherein the image processing device includes
an image information acquiring unit that acquires the image information of the image,
a path information acquiring unit that acquires position information of a path of an operation inputted by the user on the image,
a calculation unit that calculates a magnitude of the path from the position information of the path, and
an image processing unit that changes a degree to which to perform the image processing in accordance with the magnitude of the path, and performs the image processing with respect to the image.

11. A non-transitory computer readable medium storing a program causing a computer to execute a process, the process comprising:
acquiring image information of an image that is subjected to image processing;
acquiring position information of a path of an operation inputted by a user on the image;
calculating a magnitude of the path from the position information of the path; and
changing a degree to which to perform the image processing in accordance with the magnitude of the path, and performing the image processing with respect to the image.
